(19) United States
(12) Patent Application Publication
(10) Pub. No.: US 2020/0165479 A1
(43) Pub. Date: May 28, 2020

(54) ELECTROPHORETIC INK PROVIDING BISTABILITY

(71) Applicant: BASF SE, Ludwigshafen am Rhein (DE)

(72) Inventors: Gerardus DE KEYZER, Basel (CH); Ying GUO, Riehen (CH)

(73) Assignee: BASF SE, Ludwigshafen am Rhein (DE)

(21) Appl. No.: 16/615,279

(22) PCT Filed: May 8, 2018
(86) PCT No.: PCT/EP2018/061915

§ 371 Date: Nov. 20, 2019

(30) Foreign Application Priority Data
Jun. 1, 2017 (EP) 17174033.5

(51) Int. Cl. C09D 11/52; C09D 11/037; C09D 11/03; C09D 11/102; G02F 1/167; E06B 9/24

(52) U.S. Cl. CPC C09D 11/52; C09D 11/037; C09D 11/03; C08K 9/06; G02F 1/167; E06B 9/24; C08K 2201/001; C09D 11/102

(57) ABSTRACT

The present invention refers to an electrophoretic ink, a method for preparing an electrophoretic ink, an electrophoretic display comprising the electrophoretic ink, a smart window comprising the electrophoretic ink as well as the use of the electrophoretic ink in electrophoretic displays or smart windows and the use of at least one surface-treated silica for improving the bistability of an electrophoretic ink.

### FIELD OF THE INVENTION

The present invention refers to an electrophoretic ink, a method for preparing an electrophoretic ink, an electrophoretic display comprising the electrophoretic ink, a smart window comprising the electrophoretic ink as well as the use of the electrophoretic ink in electrophoretic displays or smart windows and the use of at least one surface-treated silica for improving the bistability of an electrophoretic ink.

### BACKGROUND OF THE INVENTION

Reflective and bright displays featured as low-cost and outdoor readable as well as smart windows have great market potential. The current reflective displays are usually based on electrophoretic phenomenon and thus are referred to as electrophoretic displays (e-displays).

Such e-displays and smart windows are well known in the art. For example, U.S. Pat. No. 7,110,162 B2 refers to an electrophoretic ink comprising a fluorinated solvent as a continuous phase, charged pigment particles or pigment containing microcapsules as a dispersed phase and a charge controlling agent which comprises: (i) a soluble fluorinated electron accepting or proton donating compound or polymer in the continuous phase and an electron donating or proton accepting compound or polymer in the dispersed phase; or (ii) a soluble fluorinated electron donating or proton accepting compound or polymer in the continuous phase and an electron accepting or proton donating compound or polymer in the dispersed phase. EP 1 231 500 A2 refers to electrically addressable ink comprising a microcapsule, said microcapsule comprising: a first particle having a first charge; and a second particle having a second charge; wherein applying an electric field having a first polarity to said microcapsule effects a perceived color change by causing one of said first and second particles to migrate in a direction responsive to said field. WO 2011/046564 A1 dual color electronically addressable ink includes a non-polar carrier fluid, a first colorant of a first color, and a second colorant of a second color that is different than the first color. The first colorant includes a particle core (C1), and a basic functional group (BFG) attached to a surface of the particle core (C1). The second colorant includes a particle core (C2), and an acidic functional group (AFG) attached to a surface of the particle core (C2). The acidic functional group (AFG) and the basic functional group (BFG) are configured to interact within the non-polar carrier fluid to generate a charge on the first colorant and an opposite charge on the second colorant.

However, commercially available electrophoretic ink (e-ink) materials are typically only able to switch between a white, grey or a black reflective state. That is to say, they cannot provide a transparent state and therefore cannot be used in smart windows. Furthermore, the commercially available e-displays filled with e-ink have the drawback that they typically do not provide the desired brightness. In addition thereto, the commercially available e-displays typically provide a decreased amount of pixels, i.e. one third in red, one third in blue and one third in green, such that the colour spectrum of the displays is restricted. The application of the currently available e-inks is hence limited to e-displays and completely impossible in smart windows. Moreover, the commercially available e-inks require encapsulation and/or surface-grafting of pigments which increase the complexity of the process and the cost. Furthermore, the electrophoretic ink materials used in commercially available displays have a relatively high viscosity such that the reorientation of the materials takes several seconds if the electrical voltage is changed.

Therefore, there is a need in the art for providing an electrophoretic ink which avoids the foregoing disadvantages and especially allows for the switching between transparent and multi-coloured or translucent states when used in electrophoretic displays or smart windows. Furthermore, it is desirable to provide an electrophoretic ink having a high brightness as well as covering a large colour spectrum, i.e. all pixels in red, green and blue, when used in electrophoretic displays. Moreover, it is desirable that images on a displays comprising an e-ink are retained for some time, preferably a couple of seconds, even when all power sources are removed. That is to say, it is desirable to provide a bistable electrophoretic ink having a bistability of more than 1 second, preferably of more than 2 seconds, and most preferably of more than 5 seconds, and thus allows enough fast reorientation of the electrophoretic ink materials.

Accordingly, it is an object of the present invention to provide an electrophoretic ink, especially an electrophoretic ink that can be used in electrophoretic displays or smart windows. Furthermore, it is an object of the present invention to provide an electrophoretic ink that allows for the switching between transparent and translucent and non-transparent states in smart window applications. Furthermore, it is an object of the present invention to provide an electrophoretic ink that allows for the switching between white and black and multi-coloured states in e-display applications. It is another object of the present invention to provide an electrophoretic ink that provides a high brightness in an e-display. It is a further object of the present invention to provide an electrophoretic ink that covers a large colour spectrum. It is a further object of the present invention to provide an electrophoretic ink that provides bistability of more than 1 second, preferably of more than 2 seconds, and most preferably of more than 5 seconds, and thus allows enough fast reorientation of the electrophoretic ink materials.

### SUMMARY OF THE INVENTION

The foregoing and other objects are solved by the subject-matter of the present invention. According to a first aspect of the present invention, an electrophoretic ink is provided. The electrophoretic ink comprises
a) at least one carrier fluid,
b) pigment particles dispersed in the at least one carrier fluid,
c) a mixture of charge control agents, the mixture of charge control agents comprises
   i) at least one polydimethylsiloxane substituted primary amine and/or polydimethylsiloxane substituted secondary amine and/or polydimethylsiloxane substituted tertiary amine, and
   ii) at least one polydimethylsiloxane substituted quaternary ammonium with counterion, and
d) at least one surface-treated silica.

The inventors surprisingly found out that an electrophoretic ink as defined herein, namely an electrophoretic ink comprising at least one carrier fluid, pigment particles dispersed in the carrier fluid, a defined mixture of charge control agents and at least one surface-treated silica, can be used as electrophoretic ink in electrophoretic displays or smart windows and allows for the switching between transparent and multi-coloured or translucent states. Furthermore, the electrophoretic ink has a high brightness and covers a large colour spectrum. Furthermore, the electrophoretic ink is bistable for more than 2 seconds, i.e. of more than 5 seconds, and thus allows enough fast reorientation of the electrophoretic ink materials.

According to another aspect of the present invention, a method for preparing an electrophoretic ink is provided. The method comprising the steps of
a) providing at least one carrier fluid as defined herein,
b) providing pigment particles as defined herein,
c) optionally providing at least one dispersing agent as defined herein,
d) providing a mixture of charge control agents as defined herein,
e) providing at least one surface-treated silica as defined herein, and
f) combining the at least one carrier fluid of step a), the pigment particles of step b), the optional dispersing agent of step c), the mixture of charge control agents of step d) and the at least one surface-treated silica of step e).

According to a further aspect of the present invention, an electrophoretic display comprising a) a top layer and a bottom layer, wherein at least one is transparent, and b) an array of cells sandwiched between the top layer and the bottom layer and the cells are at least partially filled with the electrophoretic ink, as defined herein, is provided.

According to still another aspect of the present invention, a smart window comprising a) a top layer and a bottom layer, wherein the top layer and the bottom layer are transparent, and b) an array of cells sandwiched between the top layer and the bottom layer and the cells are at least partially filled with the electrophoretic ink, as defined herein, is provided.

According to an even further aspect of the present invention, the use of the electrophoretic ink as defined herein in electrophoretic displays or smart windows is provided.

According to a still further aspect of the present invention, the use of at least one surface-treated silica as defined herein, preferably together with a mixture of charge control agents as defined herein, for improving the bistability of an electrophoretic ink is provided.

Advantageous embodiments of the inventive electrophoretic ink are defined in the corresponding sub-claims.

According to one embodiment, the at least one carrier fluid is selected from the group comprising aliphatic hydrocarbons, halogenated alkanes, silicon oils and mixtures thereof.

According to another embodiment, the pigment particles are selected from the group consisting of color pigments, effect pigments, electrically conductive pigments, magnetically shielding pigments, fluorescent pigments, extender pigments, anticorrosion pigments, organic pigments, inorganic pigments and mixtures thereof.

According to yet another embodiment, the electrophoretic ink comprises at least one dispersing agent, preferably the at least one dispersing agent is of the following Formula (I)

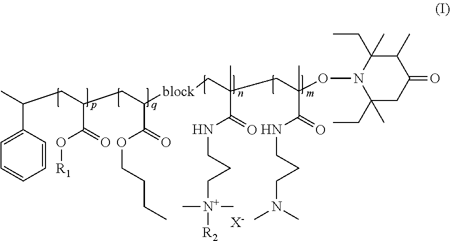

wherein p+q is an integer in the range from 30 to 200, n+m is an integer in the range from 5 to 50, X⁻ is an anion of a monovalent organic or inorganic acid, R₁ is a C₄-C₂₂-linear or branched alkyl group and R₂ is a C₁-C₁₂-comprising group.

According to one embodiment, the mixture of charge control agents comprises the at least one polydimethylsiloxane substituted primary amine and/or polydimethylsiloxane substituted secondary amine and/or polydimethylsiloxane substituted tertiary amine of i) and the at least one polydimethylsiloxane substituted quaternary ammonium with counterion of ii) in a weight ratio [i)/ii)] ranging from 1:10 to 1:1.5, preferably from 1:8 to 1:1.8 and most preferably from 1:5 to 1:2.

According to another embodiment, the at least one polydimethylsiloxane substituted primary amine and/or polydimethylsiloxane substituted secondary amine and/or polydimethylsiloxane substituted tertiary amine of i) is a polydimethylsiloxane substituted tertiary amine.

According to yet another embodiment, the at least one polydimethylsiloxane substituted primary amine and/or polydimethylsiloxane substituted secondary amine and/or polydimethylsiloxane substituted tertiary amine of i) is a compound of the following Formula (IIa)

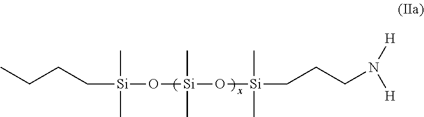

wherein x is an integer in the range from 5 to 20, and/or a compound of the following Formula (IIb)

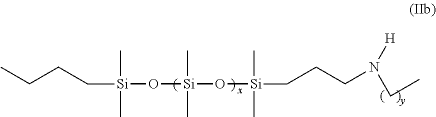

wherein x is an integer in the range from 5 to 20 and y is an integer in the range from 0 to 12, and/or a compound of the following Formula (IIc)

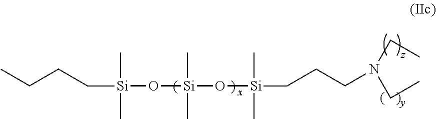

According to one embodiment, the at least one polydimethylsiloxane substituted quaternary ammonium with counterion of ii) is a compound of the following Formula (III)

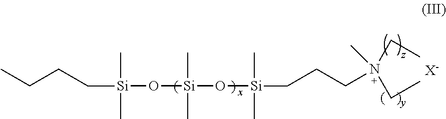

wherein x is an integer in the range from 5 to 20; y and z are independently from each other and are an integer in the range from 0 to 12 and X⁻ is selected from the group consisting of iodide, bromide, chloride, methylsulfate anion and ethylsulfate anion.

According to another embodiment, the at least one polydimethylsiloxane substituted quaternary ammonium with counterion of ii) is a compound of the following Formula (IV)

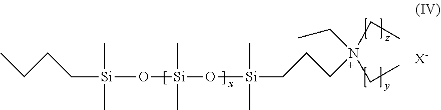

wherein x is an integer in the range from 5 to 20; y and z are independently from each other and are an integer in the range from 0 to 12 and X⁻ is selected from the group consisting of iodide, bromide, chloride, methylsulfate anion and ethylsulfate anion.

According to yet another embodiment, the at least one surface-treated silica i) is at least one surface-treated fumed silica, and/or ii) comprises aluminum oxide in an amount ranging from 0.5 to 22 wt.-%, based on the total weight of the at least one surface-treated silica, and/or iii) comprises a treatment layer on the surface of the at least one surface-treated silica comprising a silicon-containing compound selected from the group consisting of silanes and/or reaction products thereof, siloxanes and/or reaction products thereof, silazanes and/or reaction products thereof, silicon oils and/or reaction products thereof, and mixtures thereof.

According to one embodiment, the at least one surface-treated silica has i) a weight median particle size d₅₀ from 4 to 200 nm, preferably from 5 to 180 nm, and most preferably from 5 to 150 nm, and/or ii) a specific surface area (BET) of from 10 to 400 m²/g, preferably of from 25 to 350 m²/g and most preferably of from 30 to 300 m²/g, as measured using nitrogen and the BET method according to ISO 9277.

In the following, the details and preferred embodiments of the inventive process will be described in more detail. It is to be understood that these technical details and embodiments also apply to the inventive products and uses.

### DETAILED DESCRIPTION OF THE INVENTION

The electrophoretic ink comprises
a) at least one carrier fluid,
b) pigment particles dispersed in the at least one carrier fluid,
c) a mixture of charge control agents, the mixture of charge control agents comprises
   i) at least one polydimethylsiloxane substituted primary amine and/or polydimethylsiloxane substituted secondary amine and/or polydimethylsiloxane substituted tertiary amine, and
   ii) at least one polydimethylsiloxane substituted quaternary ammonium with counterion, and
d) at least one surface-treated silica.

Accordingly, one essential component of the electrophoretic ink is the at least one carrier fluid.

The term “at least one” means that the carrier fluid comprises, preferably consists of, one or more carrier fluid(s).

In one embodiment, the at least one carrier fluid comprises, preferably consists of, one carrier fluid. Alternatively, the at least one carrier fluid comprises, preferably consists of, two or more carrier fluids. For example, the at least one carrier fluid comprises, preferably consists of, two or three carrier fluids. In other words, if the at least one carrier fluid comprises, preferably consists of, two or more carrier fluids, the at least one carrier fluid comprises, preferably consists of, a mixture of different carrier fluids.

If the at least one carrier fluid is a mixture of different carrier fluids, the mixture comprises, preferably consists of, two to five carrier fluids. For example, the mixture of carrier fluids comprises, preferably consists of, two or three carrier fluids.

Preferably, the at least one carrier fluid comprises, more preferably consists of, one carrier fluid.

For example, the at least one carrier fluid has a low dielectric constant, for example, about 4 or less, such as in the range from 0.5 to 2.

In one embodiment, the at least one carrier fluid is substantially free of ions.

Suitable carrier fluids are selected from the group comprising aliphatic hydrocarbons, halogenated alkanes, silicon oils and mixtures thereof.

Examples of aliphatic hydrocarbons include heptane, octane, nonane, decane, dodecane, tetradecane, hexane, cyclohexane, paraffinic solvents such as ISOPAR™ (Exxon), NORPAR™ (Exxon), SHELL-SOL™ (Shell), and SOL-TROL™ (Shell) series. The use of aliphatic hydrocarbons as the at least one carrier fluid is advantageous due to their good dielectric strength and nonreactivity.

The aliphatic hydrocarbon preferably has a dielectric constant of about 4 or less, such as in the range from 0.5 to 2. Additionally or alternatively, the aliphatic hydrocarbon has a refractive index in the range from 1.4 to 1.5, such as in the range from 1.4 to 1.45.

In one embodiment, the aliphatic hydrocarbon preferably has a density in the range from 0.6 to 0.8 gcm⁻³, such as in the range from 0.7 to 0.8 gcm⁻³.

Halogenated alkanes may include partially or completely halogenated alkanes. For example, the halogenated alkane is selected from the group comprising, preferably consisting of, tetrafluorodibromoethylene, tetrachloroethylene, trifluorochloroethylene, carbon tetrachloride and mixtures thereof.

The halogenated alkane preferably has a dielectric constant of about 4 or less, such as in the range from 1.5 to 2. Additionally or alternatively, the halogenated alkane has a refractive index of about 1.4 or less, such as in the range from 1.3 to 1.4.

In one embodiment, the halogenated alkane preferably has a density in the range from 1.0 to 1.9 gcm⁻³, such as in the range from 1.3 to 1.8 gcm⁻³.

Examples of silicone oils include octamethyl cyclosiloxane, poly(methyl phenyl siloxane), hexamethyldisiloxane, polydimethylsiloxane and mixtures thereof.

The silicone oil preferably has a dielectric constant of about 3 or less, such as in the range from 2 to 2.8. Additionally or alternatively, the silicone oil has a refractive index of 1.45 or less, such as in the range from 1.4 to 1.45.

In one embodiment, the silicone oil preferably has a density in the range from 0.8 to 1.0 gcm⁻³, such as in the range from 0.9 to 1.0 gcm⁻³.

The electrophoretic ink preferably comprises the at least one carrier fluid in an amount ranging from 30 to 95 wt.-%, more preferably from 40 to 94.5 wt.-% and most preferably from 50 to 94 wt.-%, based on the total weight of the electrophoretic ink.

It is a further requirement of the present invention that the electrophoretic ink comprises pigment particles dispersed in the at least one carrier fluid.

It is appreciated that the electrophoretic ink is preferably free of pigments having surface functionalization such as encapsulated pigments and/or surface-grafted pigments.

In one embodiment, the pigment particles comprise, preferably consist of, one kind of pigment particles. Alternatively, the pigment particles comprise, preferably consist of, two or more kinds of pigment particles. For example, the pigment particles comprise, preferably consist of, two or three kinds of pigment particles.

Preferably, the pigment particles comprise, preferably consist of, one kind of pigment particles.

In one embodiment, the pigment particles are selected from the group consisting of color pigments, effect pigments, electrically conductive pigments, magnetically shielding pigments, fluorescent pigments, extender pigments, anticorrosion pigments, organic pigments, inorganic pigments and mixtures thereof. Preferably, the pigment particles are color pigments.

If the pigment particles are color pigments, the pigment particles are preferably selected from black pigment particles, cyan pigment particles, magenta pigment particles, yellow pigment particles and mixtures thereof.

It is appreciated that the pigment particles, preferably the color pigments, and most preferably the pigment particles selected from black pigment particles, cyan pigment particles, magenta pigment particles, yellow pigment particles and mixtures thereof are generally well known in the art and thus do not need to be described in more detail in the present application. Furthermore, all pigment particles which are well known to be suitably used in the products to be prepared can be used in the electrophoretic ink of the present invention.

Black pigment particles are preferably selected from pigment particles of the following Formula (a) and/or Formula (b)

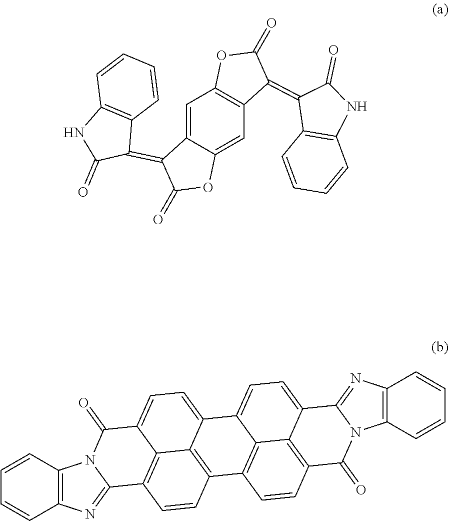 [SMILES: O=C1Nc2ccccc2/C1=C1/C(=O)Oc2cc3c(cc21)OC(=O)/C3=C1\C(=O)Nc2ccccc21 ; O=c1c2ccc3c4ccc5c6c(ccc(c7ccc(c2c37)c2nc3ccccc3n12)c46)c(=O)n1c2ccccc2nc51]

More preferably, black pigment particles are selected from pigment particles of Formula (a) or Formula (b).

Cyan pigment particles are preferably selected from pigment particles of the following Formula (c) and/or Formula (d)

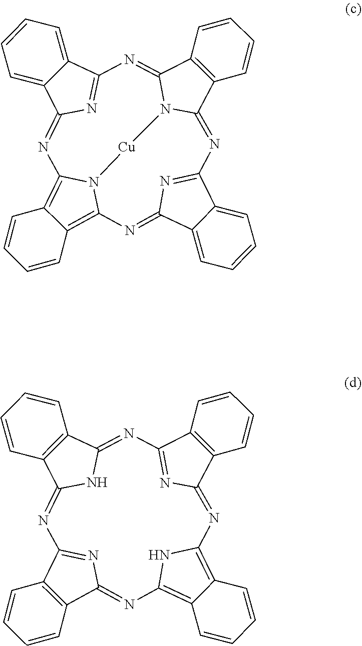

More preferably, cyan pigment particles are selected from pigment particles of Formula (c) or Formula (d).

Magenta pigment particles are preferably selected from pigment particles of the following Formula (e) and/or Formula (f) and/or Formula (g)

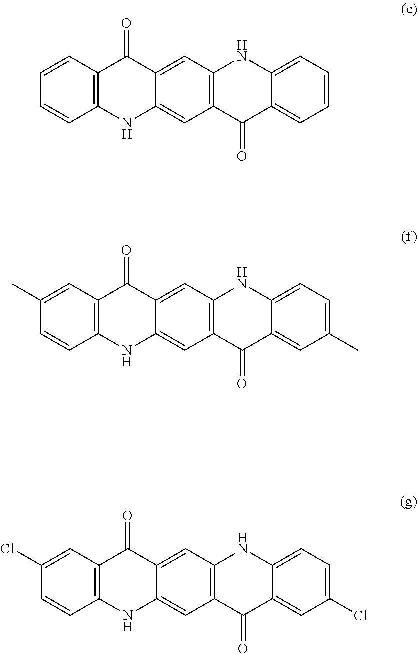

More preferably, magenta pigment particles are selected from pigment particles of Formula (e) or Formula (f) or Formula (g).

Yellow pigment particles are preferably selected from pigment particles of the following Formula (h) and/or Formula (i) and/or Formula (j) and/or Formula (k)

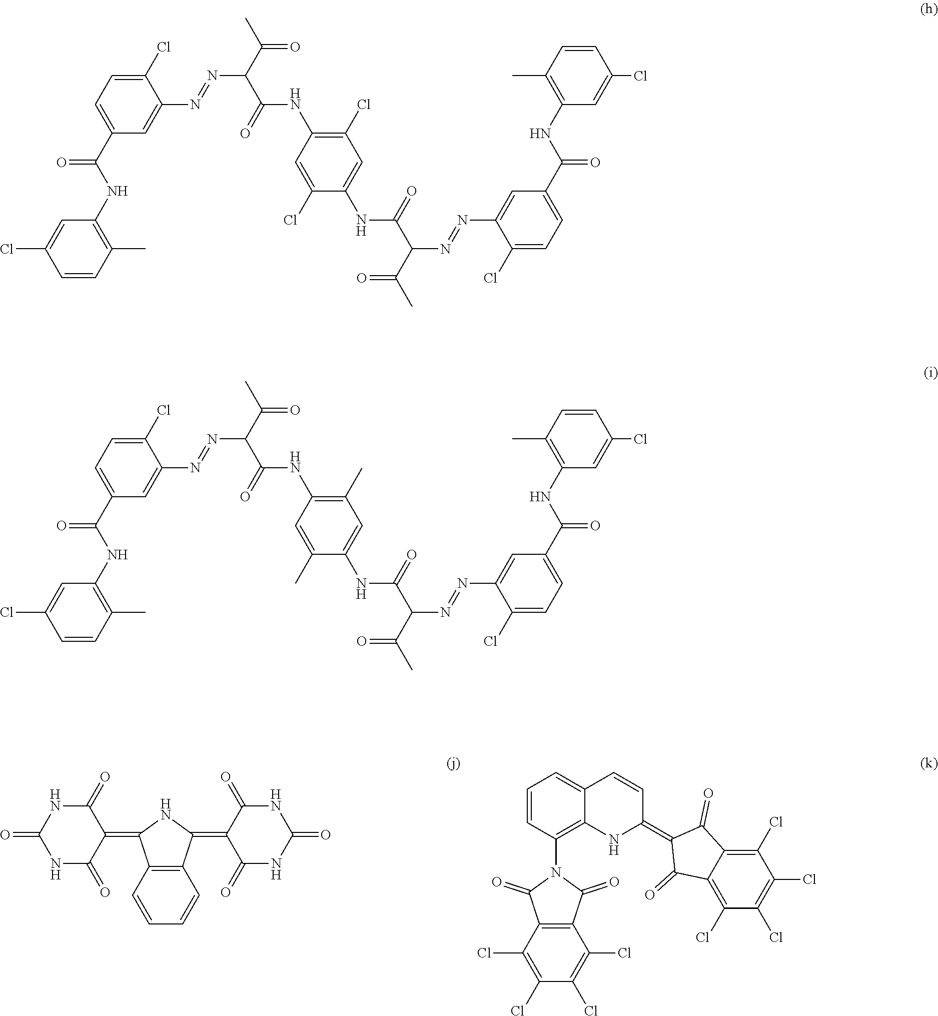 [SMILES: CC(=O)C(/N=N/c1cc(C(=O)Nc2cc(Cl)ccc2C)ccc1Cl)C(=O)Nc1cc(Cl)c(NC(=O)C(/N=N/c2cc(C(=O)Nc3cc(Cl)ccc3C)ccc2Cl)C(C)=O)cc1Cl ; CC(=O)C(/N=N/c1cc(C(=O)Nc2cc(Cl)ccc2C)ccc1Cl)C(=O)Nc1cc(C)c(NC(=O)C(/N=N/c2cc(C(=O)Nc3cc(Cl)ccc3C)ccc2Cl)C(C)=O)cc1C ; O=C1NC(=O)C(=c2[nH]c(=C3C(=O)NC(=O)NC3=O)c3ccccc23)C(=O)N1 ; O=C1C(=C2C=Cc3cccc(N4C(=O)c5c(Cl)c(Cl)c(Cl)c(Cl)c5C4=O)c3N2)C(=O)c2c(Cl)c(Cl)c(Cl)c(Cl)c21]

More preferably, yellow pigment particles are selected from pigment particles of Formula (h) or Formula (i) or Formula (j) or Formula (k).

It is appreciated that also DPP red and halogenated phthalocyanines can be used as pigment particles.

The pigment particles preferably have a particle size d₅₀ of ≤100 nm, preferably of ≤75 nm and most preferably of ≤50 nm. The value d₅₀ refers to the weight median particle size, i.e. 50 wt.-% of all particles are bigger or smaller than this particle size. The particle size can be measured by using dynamic light scattering or TEM. For example, the particle size can be determined by using a Zetasizer Nano of Malvern Instruments Ltd.

The electrophoretic ink comprises the pigment particles preferably in an amount ranging from 0.1 to 15 wt.-%, more preferably from 0.2 to 13 wt.-% and most preferably from 0.5 to 10 wt.-%, based on the total weight of the electrophoretic ink.

In one embodiment, the pigment particles are dispersed in the at least one carrier fluid by using at least one dispersing agent in order to avoid sedimentation.

Thus, the electrophoretic ink preferably comprises at least one dispersing agent.

The at least one dispersing agent can be any dispersing agent known in the art for electrophoretic inks which are used in electrophoretic displays.

The at least one dispersing agent comprises, preferably consists of, one dispersing agent. Alternatively, the at least one dispersing agent comprises, preferably consists of, two or more dispersing agent. For example, the at least one dispersing agent comprises, preferably consists of, two or three dispersing agents.

Preferably, the at least one dispersing agent comprises, more preferably consists of, one dispersing agent.

For example, the at least one dispersing agent is a compound of the following Formula (I)

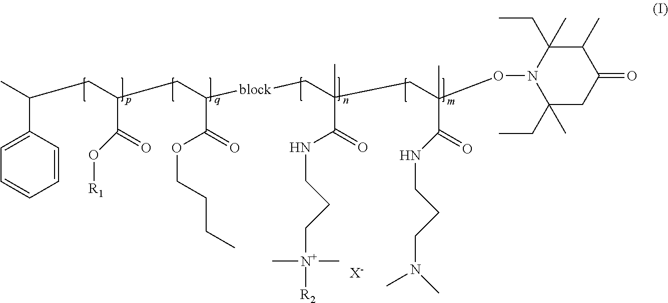

wherein p+q is an integer in the range from 30 to 200, n+m is an integer in the range from 5 to 50, X⁻ is an anion of a monovalent organic or inorganic acid, R₁ is a C₄-C₂₂-linear or branched alkyl group and R₂ is a C₁-C₁₂-comprising group.

The term “block” in Formula (I) in the meaning of the present application indicates the spatial separation of the monomers on each side of said term. That is to say, the monomers of the p and q elements form a block copolymer and the monomers of the n and m elements form another block copolymer, wherein the term “block” represents the separation of the said blocks.

It is appreciated that R₁ is a C₄-C₂₂-linear or branched alkyl group.

As used herein, the term “alkyl” is a radical of a saturated aliphatic group, including linear chain alkyl groups and branched chain alkyl groups, wherein such linear and branched chain alkyl groups may each be optionally substituted, e.g. with a hydroxyl group.

Thus, R₁ can be C₄-C₂₂ linear or branched alkyl such as substituted or unsubstituted C₄-C₂₂ linear or branched alkyl, preferably R₁ is C₆-C₂₀ linear or branched alkyl such as substituted or unsubstituted C₆-C₂₀ linear or branched alkyl, even more preferably R₁ is C₈-C₁₈ linear or branched alkyl such as substituted or unsubstituted C₈-C₁₈ linear or branched alkyl and most preferably R₁ is C₁₀-C₁₆ linear or branched alkyl such as substituted or unsubstituted C₁₀-C₁₆ linear or branched alkyl.

In one embodiment, R₁ is unsubstituted C₄-C₂₂ linear alkyl, preferably unsubstituted C6-020 linear alkyl, even more preferably unsubstituted C₈-C₁₈ linear alkyl and most preferably unsubstituted C₁₀-C₁₆ linear alkyl.

As used herein, the term “C₁-C₁₂-comprising group” is a radical of an unsubstituted or substituted saturated aliphatic or aromatic group, including unsubstituted or substituted linear chain alkyl groups and unsubstituted or substituted branched chain alkyl groups and unsubstituted or substituted aromatic groups, preferably substituted aromatic groups.

Thus, R₂ can be C₁-C₁₂-alkyl such as unsubstituted, linear or branched C₁-C₁₂-alkyl, preferably R₂ is C₂-C₁₀-alkyl such as unsubstituted, linear or branched C₂-C₁₀-alkyl, more preferably R₂ is C₂-C₉-alkyl such as unsubstituted, linear or branched C₂-C₉-alkyl, even more preferably R₂ is C₂-C₈-alkyl such as unsubstituted, linear or branched C₂-C₈-alkyl. Alternatively, R₂ can be C₁-C₁₂-alkyl such as substituted, linear or branched C₁-012-alkyl, preferably R₂ is C₂-C₁₀-alkyl such as substituted, linear or branched C₂-C₁₀-alkyl, more preferably R₂ is C₂-C₉-alkyl such as substituted, linear or branched C₂-C₉-alkyl, even more preferably R₂ is C₂-C₈-alkyl such as substituted, linear or branched C₂-C₈-alkyl, for example partially or completely halogenated, such as chlorinated, linear or branched C₂-C₈-alkyl.

For example, R₂ is unsubstituted, linear C₁-C₁₂-alkyl, preferably unsubstituted, linear C₂-C₁₀-alkyl, more preferably unsubstituted, linear C₂-C₉-alkyl, and even more preferably unsubstituted, linear C₂-C₈-alkyl.

In one embodiment, R₂ is an unsubstituted aromatic C₆-C₁₂-group, preferably R₂ is an unsubstituted aromatic C₆-C₁₀-group, more preferably R₂ is an unsubstituted aromatic C₆- or C₇-group, for example a phenyl or benzyl group. Alternatively, R₂ is a substituted aromatic C₆-C₁₂-group, preferably R₂ is a substituted aromatic C₆-C₁₀-group, more preferably R₂ is a substituted aromatic C₆- or C₇-group, for example a halogenated, such as chlorinated, phenyl, methylphenyl or benzyl group, e.g. a 3-chloro-4-methylphenyl group or a 3-chloro-5-methylphenyl group.

In order to increase the affinity of the dispersing agent to the pigment particles, it is advantageous that R₂ is a substituted aromatic C₆-C₁₂-group.

It is appreciated that X⁻ is an anion of a monovalent organic or inorganic acid. For example, X⁻ is an anion of a monovalent inorganic acid such as chloride, bromide or iodide. In one embodiment, X⁻ is bromide or iodide

A specific ratio of the blocks is advantageous in order to obtain a good balance between affinity of the dispersing agent to the pigment particles and affinity of the dispersing agent to the carrier fluid. It is thus one requirement of the present invention that the sum of p+q is an integer in the range from 30 to 200 and that the sum of n+m is an integer in the range from 5 to 50.

In one embodiment, the sum of p+q is an integer in the range from 50 to 150, preferably an integer in the range from 50 to 125 and most preferably an integer in the range from 50 to 100.

It is appreciated that p is preferably an integer in the range from 45 to 60. Additionally, q is preferably an integer in the range from 15 to 30.

In one embodiment, the sum of n+m is an integer in the range from 5 to 40, preferably an integer in the range from 5 to 30 and most preferably an integer in the range from 5 to 20.

In one embodiment, n is preferably an integer in the range from 0 to 5. Additionally, m is an integer in the range from 6 to 11. For example, n is 0 and m is 11.

If present, the electrophoretic ink comprises the at least one dispersing agent preferably in an amount ranging from 0.1 to 1.5 wt.-%, more preferably from 0.15 to 1.3 wt.-% and most preferably from 0.2 to 1.0 wt.-%, based on the total weight of the electrophoretic ink.

It is appreciated that the at least one dispersing agent can be used in combination with a synergist in the electrophoretic ink of the present invention. The skilled person known what is meant by the term “synergist” and thus this term does not need to be described in more detail in the present application. Accordingly, any synergist which is well known to be suitably used in the products to be prepared can be used in the electrophoretic ink of the present invention.

The at least one dispersing agent is preferably used in combination with a synergist in the electrophoretic ink of the present invention. In one embodiment, the at least one dispersing agent is used in combination with a synergist and pigment particles in the electrophoretic ink of the present invention.

In order to achieve the switching between the multi-coloured and the transparent state it is essential that the electrophoretic ink comprises a specific mixture of charge control agents.

It is thus one requirement of the present invention that the mixture of charge control agents comprises
i) at least one polydimethylsiloxane substituted primary amine and/or polydimethylsiloxane substituted secondary amine and/or polydimethylsiloxane substituted tertiary amine, and
ii) at least one polydimethylsiloxane substituted quaternary ammonium with counterion.

In one embodiment the mixture of charge control agents consists of
i) at least one polydimethylsiloxane substituted primary amine and/or polydimethylsiloxane substituted secondary amine and/or polydimethylsiloxane substituted tertiary amine, and
ii) at least one polydimethylsiloxane substituted quaternary ammonium with counterion.

The term “counterion” in the meaning of the present invention refers to a monovalent or divalent anion, preferably a monovalent anion, that accompanies the at least one polydimethylsiloxane substituted quaternary ammonium in order to maintain electric neutrality. Preferably, the counterion is selected from halides or organic sulfates, more preferably the counterion is a halide or organic sulfate selected from the group consisting of iodide, bromide, chloride, methylsulfate anion, ethylsulfate anion, propylsulfate anion and butylsulfate anion.

Preferably, the mixture of charge control agents comprises the at least one polydimethylsiloxane substituted primary amine and/or polydimethylsiloxane substituted secondary amine and/or polydimethylsiloxane substituted tertiary amine of i) and the at least one polydimethylsiloxane substituted quaternary ammonium with counterion of ii) in a weight ratio [i)/ii)] ranging from 1:10 to 1:1.5, preferably from 1:8 to 1:1.8 and most preferably from 1:5 to 1:2.

The term “at least one” means that the polydimethylsiloxane substituted primary amine and/or polydimethylsiloxane substituted secondary amine and/or polydimethylsiloxane substituted tertiary amine comprises, preferably consists of, one or more polydimethylsiloxane substituted primary amine(s) and/or polydimethylsiloxane substituted secondary amine(s) and/or polydimethylsiloxane substituted tertiary amine(s).

In one embodiment, the at least one polydimethylsiloxane substituted primary amine and/or polydimethylsiloxane substituted secondary amine and/or polydimethylsiloxane substituted tertiary amine comprises, preferably consists of, one polydimethylsiloxane substituted primary amine or polydimethylsiloxane substituted secondary amine or polydimethylsiloxane substituted tertiary amine. Alternatively, the at least one polydimethylsiloxane substituted primary amine and/or polydimethylsiloxane substituted secondary amine and/or polydimethylsiloxane substituted tertiary amine comprises, preferably consists of, two or more polydimethylsiloxane substituted primary amine(s) and/or polydimethylsiloxane substituted secondary amine(s) and/or polydimethylsiloxane substituted tertiary amine(s). For example, the at least one polydimethylsiloxane substituted primary amine and/or polydimethylsiloxane substituted secondary amine and/or polydimethylsiloxane substituted tertiary amine comprises, preferably consists of, two or three polydimethylsiloxane substituted primary amine(s) and/or polydimethylsiloxane substituted secondary amine(s) and/or polydimethylsiloxane substituted tertiary amine(s). In other words, if the at least one polydimethylsiloxane substituted primary amine and/or polydimethylsiloxane substituted secondary amine and/or polydimethylsiloxane substituted tertiary amine comprises, preferably consists of, two or more polydimethylsiloxane substituted primary amine(s) and/or polydimethylsiloxane substituted secondary amine(s) and/or polydimethylsiloxane substituted tertiary amine(s), it preferably comprises, consists of, a mixture of different polydimethylsiloxane substituted primary amine(s) and/or polydimethylsiloxane substituted secondary amine(s) and/or polydimethylsiloxane substituted tertiary amine(s).

If the at least one polydimethylsiloxane substituted primary amine and/or polydimethylsiloxane substituted secondary amine and/or polydimethylsiloxane substituted tertiary amine is a mixture of different compounds, the mixture comprises, preferably consists of, two to five polydimethylsiloxane substituted primary amine(s) and/or polydimethylsiloxane substituted secondary amine(s) and/or polydimethylsiloxane substituted tertiary amine(s). For example, the mixture comprises, preferably consists of, two or three polydimethylsiloxane substituted primary amine(s) and/or polydimethylsiloxane substituted secondary amine(s) and/or polydimethylsiloxane substituted tertiary amine(s).

In one embodiment, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted secondary amine and polydimethylsiloxane substituted tertiary amine.

In an alternative embodiment, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted secondary amine or polydimethylsiloxane substituted tertiary amine. For example, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted secondary amine. For example, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine and polydimethylsiloxane substituted tertiary amine.

In an alternative embodiment, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted primary amine or polydimethylsiloxane substituted secondary amine and polydimethylsiloxane substituted tertiary amine. For example, the at least one polydimethylsiloxane substituted primary amine and/or polydimethylsiloxane substituted secondary amine and/or polydimethylsiloxane substituted tertiary amine comprises, preferably consists of, a polydimethylsiloxane substituted secondary amine and polydimethylsiloxane substituted tertiary amine.

Especially good results are obtained if the at least one polydimethylsiloxane substituted primary amine and/or polydimethylsiloxane substituted secondary amine and/or polydimethylsiloxane substituted tertiary amine comprises a polydimethylsiloxane substituted tertiary amine. Thus, if the at least one polydimethylsiloxane substituted primary amine and/or polydimethylsiloxane substituted secondary amine and/or polydimethylsiloxane substituted tertiary amine is a mixture of compounds, the mixture preferably comprises, more preferably consists of, a polydimethylsiloxane substituted primary amine and polydimethylsiloxane substituted tertiary amine. Alternatively, the mixture comprises a polydimethylsiloxane substituted secondary amine and polydimethylsiloxane substituted tertiary amine. Alternatively, the mixture comprises, preferably consists of, a polydimethylsiloxane substituted primary amine and polydimethylsiloxane substituted secondary amine and polydimethylsiloxane substituted tertiary amine.

In one embodiment, the at least one polydimethylsiloxane substituted primary amine and/or polydimethylsiloxane substituted secondary amine and/or polydimethylsiloxane substituted tertiary amine comprises, more preferably consists of, one polydimethylsiloxane substituted primary amine or polydimethylsiloxane substituted secondary amine or polydimethylsiloxane substituted tertiary amine.

In view of the especially good results obtained with regard to the switching between the coloured and the transparent state, the at least one polydimethylsiloxane substituted primary amine and/or polydimethylsiloxane substituted secondary amine and/or polydimethylsiloxane substituted tertiary amine of i) is preferably a polydimethylsiloxane substituted tertiary amine.

It is appreciated that the at least one polydimethylsiloxane substituted primary amine and/or polydimethylsiloxane substituted secondary amine and/or polydimethylsiloxane substituted tertiary amine of i) is preferably a compound of the following Formula (IIa)

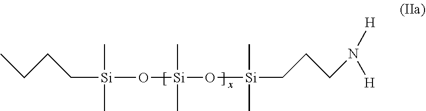

wherein x is an integer in the range from 5 to 20, and/or a compound of the following Formula (IIb)

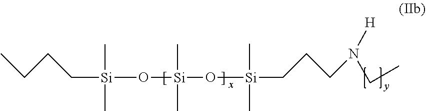

wherein x is an integer in the range from 5 to 20 and y is an integer in the range from 0 to 12, and/or a compound of the following Formula (IIc)

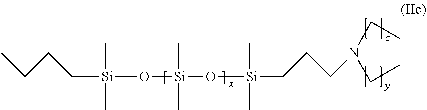

wherein x is an integer in the range from 5 to 20 and y and z are independently from each other and are integer in the range from 0 to 12.

For example, the at least one polydimethylsiloxane substituted primary amine of i) is preferably a compound of the following Formula (IIa),

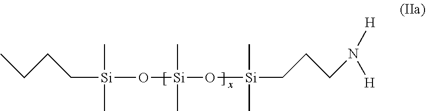

wherein x is an integer in the range from 7 to 17, preferably x is an integer in the range from 9 to 15, more preferably x is an integer in the range from 10 to 13 and most preferably x is 10 or 12.

Additionally or alternatively, the at least one polydimethylsiloxane substituted secondary amine of i) is preferably a compound of the following Formula (IIb)

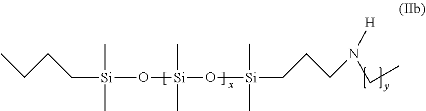

wherein x is an integer in the range from 7 to 17 and y is an integer in the range from 0 to 12, preferably x is an integer in the range from 9 to 15 and y is an integer in the range from 0 to 9, more preferably x is an integer in the range from 10 to 13 and y is an integer in the range from 0 to 7 and most preferably x is 10 or 12 and y is an integer in the range from 1 to 5, e.g. y is an integer in the range from 2 to 4 such as 3.

Additionally or alternatively, the at least one polydimethylsiloxane substituted tertiary amine of i) is preferably a compound of the following Formula (IIc)

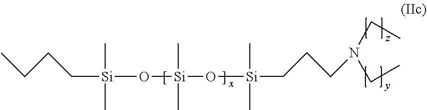

wherein x is an integer in the range from 7 to 17 and y and z are independently from each other and are an integer in the range from 0 to 12, preferably x is an integer in the range from 9 to 15 and y and z are independently from each other and are an integer in the range from 0 to 9, more preferably x is an integer in the range from 10 to 13 and y and z are independently from each other and are an integer in the range from 0 to 7 and most preferably x is 10 or 12 and y and z are independently from each other and are an integer in the range from 1 to 5, e.g. y and z are independently from each other and are an integer in the range from 2 to 4 such as 3.

Preferably, the at least one polydimethylsiloxane substituted primary amine and/or polydimethylsiloxane substituted secondary amine and/or polydimethylsiloxane substituted tertiary amine of i) is a compound of the Formula (IIc).

It is appreciated that the at least one polydimethylsiloxane substituted primary amine and/or polydimethylsiloxane substituted secondary amine and/or polydimethylsiloxane substituted tertiary amine of i) has a viscosity in the range from 5 to 15 mPas, preferably in the range from 8 to 12 mPas. The viscosity was determined by using a Brookfield viscometer; samples were maintained at 25 ° C.±2° C. during operation.

Furthermore, it is required that the mixture of charge control agents comprises at least one polydimethylsiloxane substituted quaternary ammonium with counterion.

The term “at least one” means that the polydimethylsiloxane substituted quaternary ammonium with counterion comprises, preferably consists of, one or more polydimethylsiloxane substituted quaternary ammonium(s) with counterion.

In one embodiment, the at least polydimethylsiloxane substituted quaternary ammonium with counterion comprises, preferably consists of, one polydimethylsiloxane substituted quaternary ammonium with counterion. Alternatively, the at least one polydimethylsiloxane substituted quaternary ammonium with counterion comprises, preferably consists of, two or more polydimethylsiloxane substituted quaternary ammonium(s) with counterion. For example, the at least one polydimethylsiloxane substituted quaternary ammonium with counterion comprises, preferably consists of, two or three polydimethylsiloxane substituted quaternary ammonium(s) with counterion. In other words, if the at least one polydimethylsiloxane substituted quaternary ammonium with counterion comprises, preferably consists of, two or more polydimethylsiloxane substituted quaternary ammoniums with counterion, the polydimethylsiloxane substituted quaternary ammonium with counterion comprises, preferably consists of, a mixture of different polydimethylsiloxane substituted quaternary ammonium(s) with counterion.

If the at least one polydimethylsiloxane substituted quaternary ammonium with counterion is a mixture of different compounds, the mixture comprises, preferably consists of, two to five polydimethylsiloxane substituted quaternary ammonium(s) with counterion. For example, the mixture comprises, preferably consists of, two or three polydimethylsiloxane substituted quaternary ammonium(s) with counterion.

Preferably, the at least one polydimethylsiloxane substituted quaternary ammonium with counterion is one polydimethylsiloxane substituted quaternary ammonium with counterion.

In one embodiment, the at least one polydimethylsiloxane substituted quaternary ammonium with counterion of ii) is a compound of the following Formula (III)

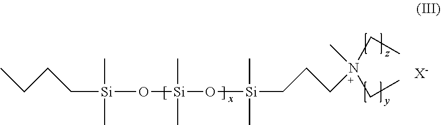

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (III)

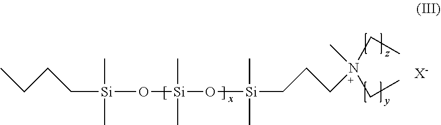

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Alternatively, the at least one polydimethylsiloxane substituted quaternary ammonium with counterion of ii) is a compound of the following Formula (III)

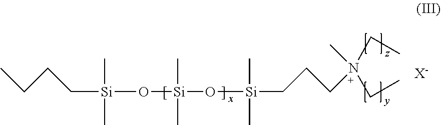

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion.

Preferably, the at least one polydimethylsiloxane substituted quaternary ammonium with counterion of ii) is a compound of the following Formula (III)

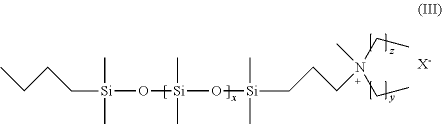

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (III)

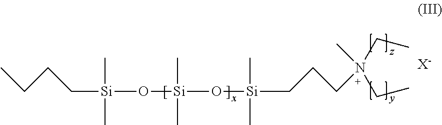

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion.

In an alternative embodiment, the at least one polydimethylsiloxane substituted quaternary ammonium with counterion of ii) is a compound of the following Formula (IV)

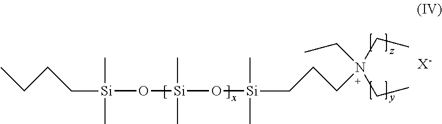

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (IV)

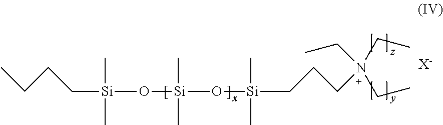

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Alternatively, the at least one polydimethylsiloxane substituted quaternary ammonium with counterion of ii) is a compound of the following Formula (IV)

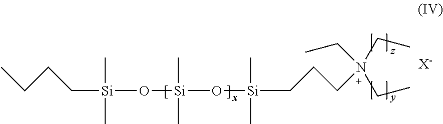

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion.

Preferably, the at least one polydimethylsiloxane substituted quaternary ammonium with counterion of ii) is a compound of the following Formula (IV)

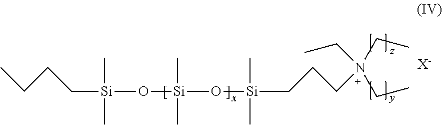

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion.

For example, the at least one polydimethylsiloxane substituted quaternary ammonium with counterion of ii) is a compound of the following Formula (IV)

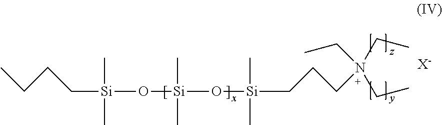

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion.

It is appreciated that the at least one polydimethylsiloxane substituted quaternary ammonium with counterion of ii) has a viscosity in the range from 300 to 400 mPas, preferably in the range from 330 to 360 mPas. The viscosity was determined by using a Brookfield viscometer; samples were maintained at 25 ° C.±2° C. during operation.

Thus, it is preferred that the mixture of charge control agents comprises, preferably consists of,
i) at least one polydimethylsiloxane substituted primary amine and/or polydimethylsiloxane substituted secondary amine and/or polydimethylsiloxane substituted tertiary amine of the Formula (IIa) and/or Formula (IIb) and/or Formula (IIc) and
ii) at least one polydimethylsiloxane substituted quaternary ammonium with counterion of the following Formula (III)

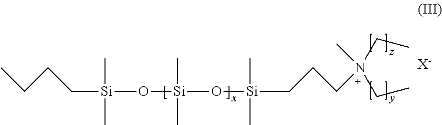

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

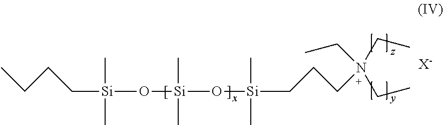

wherein x is an integer in the range from 5 to 20; y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Preferably, the mixture of charge control agents comprises, preferably consists of,
i) at least one polydimethylsiloxane substituted tertiary amine of the following Formula (IIc)

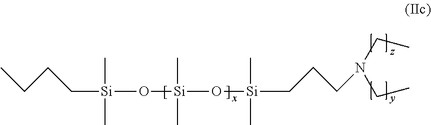

wherein x is an integer in the range from 7 to 17 and y and z are independently from each other and are an integer in the range from 0 to 12, and
ii) at least one polydimethylsiloxane substituted quaternary ammonium with counterion of the following Formula (III)

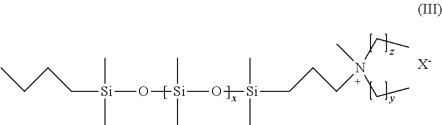

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

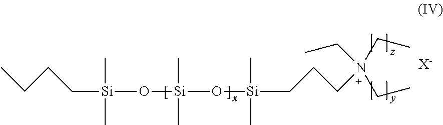

wherein x is an integer in the range from 7 to 17 and y and z are independently from each other and are an integer in the range from 0 to 12 and X⁻ is selected from the group consisting of iodide, bromide, chloride, methylsulfate anion, ethylsulfate anion, propylsulfate anion and butylsulfate anion.

Preferably, the mixture of charge control agents comprises, preferably consists of,
i) at least one polydimethylsiloxane substituted tertiary amine of the following Formula (IIc)

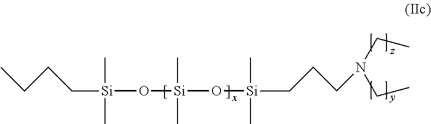

wherein x is an integer in the range from 9 to 15 and y and z are independently from each other and are an integer in the range from 0 to 9, and
ii) at least one polydimethylsiloxane substituted quaternary ammonium with counterion of the following Formula (III)

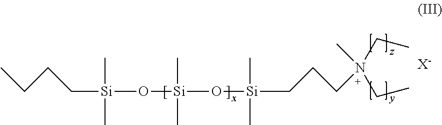

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

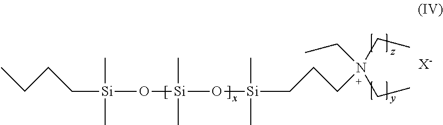

wherein x is an integer in the range from 9 to 15 and y and z are independently from each other and are an integer in the range from 0 to 9 and X⁻ is selected from the group consisting of iodide, bromide, chloride, methylsulfate anion, ethylsulfate anion, propylsulfate anion and butylsulfate anion.

More preferably, the mixture of charge control agents comprises, preferably consists of,
i) at least one polydimethylsiloxane substituted tertiary amine of the following Formula (IIc)

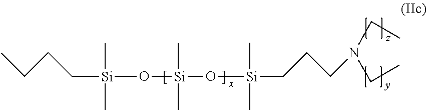

wherein x is an integer in the range from 10 to 13 and y and z are independently from each other and are an integer in the range from 0 to 7, and
ii) at least one polydimethylsiloxane substituted quaternary ammonium with counterion of the following Formula (III)

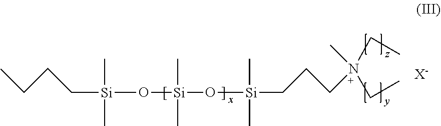

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

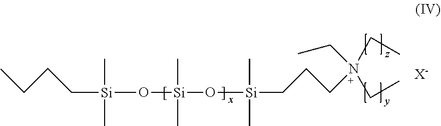

wherein x is an integer in the range from 10 to 13 and y and z are the same integer in the range from 0 to 7 and X⁻ is selected from the group consisting of iodide, bromide, chloride, methylsulfate anion, ethylsulfate anion, propylsulfate anion and butylsulfate anion.

Most preferably, the mixture of charge control agents comprises, preferably consists of,
i) at least one polydimethylsiloxane substituted tertiary amine of the following Formula (IIc)

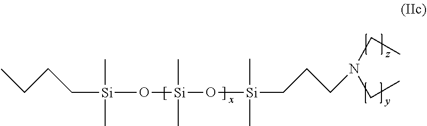

wherein x is 10 or 12 and y and z are independently from each other and are an integer in the range from 1 to 5, e.g. y and z are independently from each other and are an integer in the range from 2 to 4 such as 3, and
ii) at least one polydimethylsiloxane substituted quaternary ammonium with counterion of the following Formula (III)

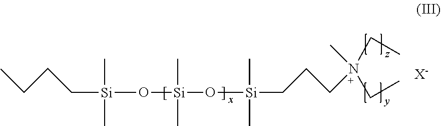

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion, or
iii) at least one polydimethylsiloxane substituted quaternary ammonium with counterion of the following Formula (IV)

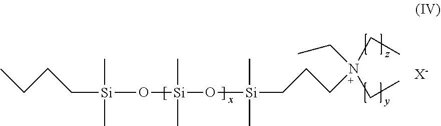

wherein x is 10 or 12 and y and z are the same integer in the range from 1 to 5, preferably y and z are the same integer in the range from 2 to 4, e.g. y and z are 3, and X⁻ is selected from the group consisting of iodide, bromide, chloride, methylsulfate anion, ethylsulfate anion, propylsulfate anion and butylsulfate anion.

As regards the mixture of charge control agents, it is preferred that x in Formula (IIc) and Formula (III) or Formula (IV) is the same and/or y in Formula (IIc) and Formula (III) or Formula (IV) is the same and/or z in Formula (IIc) and Formula (III) or Formula (IV) is the same. For example, x in Formula (IIc) and Formula (III) or Formula (IV) is the same and y in Formula (IIc) and Formula (III) or Formula (IV) is the same and z in Formula (IIc) and Formula (III) or Formula (IV) is the same. Alternatively, x in Formula (IIc) and Formula (III) or Formula (IV) is the same or y in Formula (IIc) and Formula (III) or Formula (IV) is the same or z in Formula (IIc) and Formula (III) or Formula (IV) is the same.

In one embodiment, x in Formula (IIc) and Formula (III) or Formula (IV) is the same or y in Formula (IIc) and Formula (III) or Formula (IV) is the same and z in Formula (IIc) and Formula (III) or Formula (IV) is the same.

It is especially preferred that y and z are the same in Formula (IIc) and Formula (III) or Formula (IV).

In one embodiment, the mixture of charge control agents comprises, preferably consists of,
i) one polydimethylsiloxane substituted tertiary amine of the following Formula (IIc)

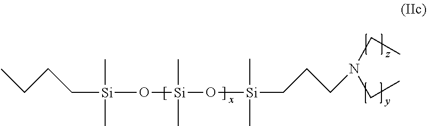

wherein x is 10 or 12 and y and z are independently from each other and are an integer in the range from 1 to 5, e.g. y and z are independently from each other and are an integer in the range from 2 to 4 such as 3, and
ii) one polydimethylsiloxane substituted quaternary ammonium with counterion of the following Formula (III)

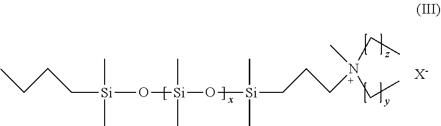

wherein x is 10 and y and z are the same integer in the range from 1 to 5, preferably y and z are the same integer in the range from 2 to 4, e.g. y and z are 3, and X⁻ is an iodide or methylsulfate anion, and/or
iii) one polydimethylsiloxane substituted quaternary ammonium with counterion of the following Formula (III)

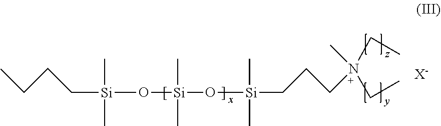

iv) wherein x is 12 and y and z are the same integer in the range from 1 to 5, preferably y and z are the same integer in the range from 2 to 4, e.g. y and z are 3, and X⁻ is an iodide or methylsulfate anion.

The electrophoretic ink comprises the mixture of charge control agents preferably in an amount of 5 to 40 wt.-%, more preferably in an amount of 10 to 30 wt.-%, based on the total weight of the electrophoretic ink.

For example, the electrophoretic ink comprises the mixture of charge control agents including the counterions in an amount of 5 to 40 wt.-%, more preferably in an amount of 10 to 30 wt.-%, based on the total weight of the electrophoretic ink.

In one embodiment, the electrophoretic ink comprises the at least one polydimethylsiloxane substituted primary amine and/or polydimethylsiloxane substituted secondary amine and/or polydimethylsiloxane substituted tertiary amine in an amount of 1 to 12 wt.-%, more preferably in an amount of 2 to 8 wt.-%, based on the total weight of the electrophoretic ink.

Additionally or alternatively, the electrophoretic ink comprises the at least one polydimethylsiloxane substituted quaternary ammonium with counterion in an amount of 5 to 17 wt.-%, more preferably in an amount of 7 to 15 wt.-%, based on the total weight of the electrophoretic ink.

It is appreciated that the amount of the at least one polydimethylsiloxane substituted quaternary ammonium with counterion in the electrophoretic ink is preferably above the amount of the at least one polydimethylsiloxane substituted primary amine and/or polydimethylsiloxane substituted secondary amine and/or polydimethylsiloxane substituted tertiary amine.

Preferably, the electrophoretic ink comprises the at least one polydimethylsiloxane substituted primary amine and/or polydimethylsiloxane substituted secondary amine and/or polydimethylsiloxane substituted tertiary amine of i) and the at least one polydimethylsiloxane substituted quaternary ammonium with counterion of ii) in a weight ratio [i)/ii)] ranging from 1:10 to 1:1.5, preferably from 1:8 to 1:1.8 and most preferably from 1:5 to 1:2.

In order to improve the bistability of an electrophoretic ink to more than 15 seconds and thus to reduce the power consumption of a display comprising the e-ink, the inventors surprisingly found out that the electrophoretic ink must comprise at least one surface-treated silica.

Thus, another essential component of the electrophoretic ink is the at least one surface-treated silica.

The term “surface-treated silica” in the meaning of the present invention refers to a silica which has been contacted with a surface treatment agent such as to obtain a treatment layer on (at least a part of) the surface of the silica.

Accordingly, a “treatment layer” in the meaning of the present invention refers to a layer comprising, preferably consisting of, the surface treatment agent and/or reaction products thereof.

The term “at least one” means that the surface-treated silica comprises, preferably consists of, one or more surface-treated silica(s).

In one embodiment, the at least one surface-treated silica comprises, preferably consists of, one surface-treated silica. Alternatively, the at least one surface-treated silica comprises, preferably consists of, two or more surface-treated silicas. For example, the at least one surface-treated silica comprises, preferably consists of, two or three surface-treated silicas. In other words, if the at least one surface-treated silica comprises, preferably consists of, two or more surface-treated silicas, the at least one surface-treated silica comprises, preferably consists of, a mixture of different surface-treated silicas.

It is appreciated that the term “different” surface-treated silica refers to the same silica being (simultaneously or separately) surface treated with different surface treatment agents or to different silica, e.g. differing by the specific surface area, being surface treated with the same surface treatment agent.

The term “simultaneously” surface treated with different surface treatment agents in the meaning of the present invention means that the same silica is surface treated such that the silica comprises the different surface treatment agents in the same treatment layer.

The term “separately” surface treated with different surface treatment agents in the meaning of the present invention means that the same silica is surface treated such that the silica comprises the different surface treatment agents in different treatment layers, i.e. on different particles of the silica.

The surface-treated silica is preferably simultaneously surface treated with different surface treatment agents.

If the at least one surface-treated silica is a mixture of different surface-treated silicas, the mixture comprises, preferably consists of, two to five surface-treated silicas. For example, the mixture of surface-treated silicas comprises, preferably consists of, two or three surface-treated silicas.

Preferably, the at least one surface-treated silica comprises, more preferably consists of, one surface-treated silica. Alternatively, the at least one surface-treated silica comprises, more preferably consists of, a mixture of two different surface-treated silicas.

It is appreciated that the at least one surface-treated silica is not considered as the pigment particles dispersed in the at least one carrier fluid and thus is also not calculated to the amount of pigment particles present in the electrophoretic ink.

It is preferred that the at least one surface-treated silica is at least one surface-treated fumed silica.

The term “fumed silica” is well known by the skilled man and refers to its general meaning. Thus, a detailed description of the fumed silica is not necessary.

In one embodiment, the at least one surface-treated silica, preferably the at least one surface-treated fumed silica, has a weight median particle size d50 from 4 to 200 nm, preferably from 5 to 180 nm, and most preferably from 5 to 150 nm.

Additionally or alternatively, the at least one surface-treated silica, preferably the at least one surface-treated fumed silica, has a specific surface area (BET) of from 10 to 400 m²/g, preferably of from 25 to 350 m²/g and most preferably of from 30 to 300 m²/g, as measured using nitrogen and the BET method according to ISO 9277.

Thus, it is preferred that the at least one surface-treated silica, preferably the at least one surface-treated fumed silica, has
i) a weight median particle size d₅₀ from 4 to 200 nm, preferably from 5 to 180 nm, and most preferably from 5 to 150 nm, or
ii) a specific surface area (BET) of from 10 to 400 m²/g, preferably of from 25 to 350 m²/g and most preferably of from 30 to 300 m²/g, as measured using nitrogen and the BET method according to ISO 9277.

More preferably, the at least one surface-treated silica, preferably the at least one surface-treated fumed silica, has
i) a weight median particle size d₅₀ from 4 to 200 nm, preferably from 5 to 180 nm, and most preferably from 5 to 150 nm, and
ii) a specific surface area (BET) of from 10 to 400 m²/g, preferably of from 25 to 350 m²/g and most preferably of from 30 to 300 m²/g, as measured using nitrogen and the BET method according to ISO 9277.

It is an essential feature that the at least one silica, preferably the at least one fumed silica, is surface-treated. The surface-treatment especially results in an improvement of the bistability and thus reduces the overall power consumption of e.g. displays utilizing an e-ink comprising the surface-treated silica, preferably surface-treated fumed silica.

Advantageously, the treatment layer comprises one or more silicon-containing compound(s), preferably one or more silicon-containing compound(s) and/or reaction products thereof.

The term “reaction products” refers to products obtained by contacting the silica with one or more silicon-containing compound(s). Said reaction products are formed between the one or more silicon-containing compound(s) and molecules located at the surface of the silica, preferably the fumed silica.

In one embodiment, the treatment layer on the surface of the at least one surface-treated silica, preferably the at least one surface-treated fumed silica, comprises a silicon-containing compound selected from the group consisting of silanes and/or reaction products thereof, siloxanes and/or reaction products thereof, silazanes and/or reaction products thereof, silicon oils and/or reaction products thereof, and mixtures thereof

Such compounds are well known in the art and are available from a great variety of suppliers, e.g. as AEROSIL® R 104, AEROSIL® R 106, AEROSIL® R 208, AEROSIL® R 709, AEROSIL® R 711, AEROSIL® R 805, AEROSIL® R 816, AEROSIL® R 972, AEROSIL® R 974, AEROSIL® R 8200, AEROSIL® R 812 S, AEROSIL® R 976 S, AEROSIL® RX 50, AEROSIL® RX200, AEROSIL® RY50, AEROSIL® RY 51, AEROSIL® RY 200, AEROSIL® NX 90 S, and AEROSIL® NX 130 from EVONIK Resource Efficiency GmbH.

If the treatment layer on the surface of the at least one surface-treated silica, preferably the at least one surface-treated fumed silica, comprises a silane and/or reaction products thereof as the silicon-containing compound, the silane is preferably selected from alkylsilanes, alkoxysilanes, (meth)acrylsilane and mixtures thereof. More preferably, the treatment layer on the surface of the at least one surface-treated silica, preferably the at least one surface-treated fumed silica, comprises alkylsilanes and/or (meth)acrylsilanes.

Suitable silanes are selected from the group comprising methacrylsilane, acrylsilane, docosanylsilane, octadecylsilane, hexadecylsilane, dodecylsilane, decylsilane, octylsilane, hexylsilane, dimethyldichlorosilane, dimethoxydimethylsilane, ethyl(trimethoxy)silane, trimethoxy(propyl)silane, isobutyl(trimethoxy)silane, [3-(methacryloyloxy)propyl]trimethoxysilane, butylsilane, propylsilane, ethylsilane, tridodecylsilane, tridecylsilane, trioctylsilane, trihexylsilane, tributylsilane,tripropylsilane, triethylsilane, trimethoxy(octadecyl)silane, triethoxy(octadecyl)silane, hexadecyl(trimethoxy)silane, triethoxy(hexadecyl)silane, dodecyl(trimethoxy)silane, dodecyl(triethoxy)silane, trimethoxy(octyl)silane, triethoxy(octyl)silane, methoxy(dimethyl)octylsilane, hexyl(trimethoxy)silane, triethoxy(hexyl)silane, butyl(trimethoxy)silane, butyl(triethoxy)silane and mixtures thereof.

In one embodiment, the treatment layer on the surface of the at least one surface-treated silica, preferably the at least one surface-treated fumed silica, comprises (simultaneously or separately) (meth)acrylsilane and/or reaction products thereof and alkylsilane and/or reaction products thereof.

For example, the treatment layer on the surface of the at least one surface-treated silica, preferably the at least one surface-treated fumed silica, comprises (simultaneously or separately) [3-(methacryloyloxy)propyl]trimethoxysilane and/or reaction products thereof and alkylsilane, such as octadecylsilane, hexadecylsilane, dodecylsilane, decylsilane, octylsilane or hexylsilane, and/or reaction products thereof.

If the treatment layer on the surface of the at least one surface-treated silica, preferably the at least one surface-treated fumed silica, comprises (simultaneously or separately) (meth)acrylsilane and alkylsilane, the weight ratio of (meth)acrylsilane (and/or reaction products thereof) to alkylsilane (and/or reaction products thereof) is preferably from 85:15 to 65:35, more preferably from 80:20 to 70:30.

In one embodiment, the treatment layer on the surface of the at least one surface-treated silica, preferably the at least one surface-treated fumed silica, comprises (simultaneously or separately) [3-(methacryloyloxy)propyl]trimethoxysilane and alkylsilane such that the weight ratio of [3-(methacryloyloxy)propyl]trimethoxysilane (and/or reaction products thereof) to alkylsilane (and/or reaction products thereof) is preferably from 85:15 to 65:35, more preferably from 80:20 to 70:30.

For example, the treatment layer on the surface of the at least one surface-treated silica, preferably the at least one surface-treated fumed silica, comprises (meth)acrylsilane and/or reaction products thereof and octadecylsilane and/or reaction products thereof.

Alternatively, the treatment layer on the surface of the at least one surface-treated silica, preferably the at least one surface-treated fumed silica, comprises (meth)acrylsilane and/or reaction products thereof and hexadecylsilane and/or reaction products thereof.

Alternatively, the treatment layer on the surface of the at least one surface-treated silica, preferably the at least one surface-treated fumed silica, comprises (meth)acrylsilane and/or reaction products thereof and dodecylsilane and/or reaction products thereof.

Alternatively, the treatment layer on the surface of the at least one surface-treated silica, preferably the at least one surface-treated fumed silica, comprises (meth)acrylsilane and/or reaction products thereof and decylsilane and/or reaction products thereof.

Alternatively, the treatment layer on the surface of the at least one surface-treated silica, preferably the at least one surface-treated fumed silica, comprises (meth)acrylsilane and/or reaction products thereof and octylsilane and/or reaction products thereof.

Alternatively, the treatment layer on the surface of the at least one surface-treated silica, preferably the at least one surface-treated fumed silica, comprises (meth)acrylsilane and/or reaction products thereof and hexylsilane and/or reaction products thereof.

Again, the silica can be simultaneously or separately surface treated with (meth)acrylsilane and alkylsilane. Preferably, the silica is simultaneously surface treated with (meth)acrylsilane and alkylsilane.

Thus, the (meth)acrylsilane and/or reaction products thereof and the alkylsilane and/or reaction products thereof are preferably simultaneously on the same silica, i.e. in the same treatment layer.

If the treatment layer on the surface of the at least one surface-treated silica, preferably the at least one surface-treated fumed silica, comprises a siloxane and/or reaction products thereof as the silicon-containing compound, the siloxane is preferably a polydialkylsiloxane.

For example, if the treatment layer on the surface of the at least one surface-treated silica, preferably the at least one surface-treated fumed silica, comprises a siloxane and/or reaction products thereof as the silicon-containing compound, the siloxane is preferably selected from polydimethylsiloxane, polydiethylsiloxane, octamethylcyclotetrasiloxane and mixtures thereof.

In one embodiment, the treatment layer on the surface of the at least one surface-treated silica, preferably the at least one surface-treated fumed silica, comprises a polydialkylsiloxane and/or reaction products thereof. For example, the treatment layer on the surface of the at least one surface-treated silica, preferably the at least one surface-treated fumed silica, comprises polydimethylsiloxane and/or reaction products thereof or polydiethylsiloxane and/or reaction products thereof. Preferably, the treatment layer on the surface of the at least one surface-treated silica, preferably the at least one surface-treated fumed silica, comprises polydimethylsiloxane and/or reaction products thereof.

If the treatment layer on the surface of the at least one surface-treated silica, preferably the at least one surface-treated fumed silica, comprises a silazane and/or reaction products thereof as the silicon-containing compound, the silazane is preferably selected from hexamethyldisilazane, hexaethyldisilazane and mixtures thereof. More preferably, the treatment layer on the surface of the at least one surface-treated silica, preferably the at least one surface-treated fumed silica, comprises hexamethyldisilazane and/or reaction products thereof.

In one embodiment, the treatment layer on the surface of the at least one surface-treated silica, preferably the at least one surface-treated fumed silica, comprises silicone oil and/or reaction products thereof.

Additionally or alternatively, the at least one surface-treated silica, preferably the at least one surface-treated fumed silica, comprises aluminum oxide in an amount ranging from 0.5 to 22 wt.-%, based on the total weight of the at least one surface-treated silica. Preferably, the at least one surface-treated silica, preferably the at least one surface-treated fumed silica, comprises aluminum oxide in an amount ranging from 0.5 to 2 wt.-% or from 17 to 23 wt.-%, based on the total weight of the at least one surface-treated silica.

In one embodiment, the at least one surface-treated silica, preferably the at least one surface-treated fumed silica, comprises aluminum oxide in an amount ranging from 0.5 to 22 wt.-%, based on the total weight of the at least one surface-treated silica, and comprises a treatment layer on the surface of the at least one surface-treated silica, preferably the at least one surface-treated fumed silica, comprising a silicon-containing compound selected from the group consisting of silanes and/or reaction products thereof, siloxanes and/or reaction products thereof, silazanes and/or reaction products thereof, silicon oils and/or reaction products thereof, and mixtures thereof.

Preferably, the at least one surface-treated silica, preferably the at least one surface-treated fumed silica, only comprises a treatment layer on the surface of the at least one surface-treated silica comprising a silicon-containing compound selected from the group consisting of silanes and/or reaction products thereof, siloxanes and/or reaction products thereof, silazanes and/or reaction products thereof, silicon oils and/or reaction products thereof, and mixtures thereof. That is to say, the at least one surface-treated silica, preferably the at least one surface-treated fumed silica, is free of aluminum oxide in an amount ranging from 0.5 to 22 wt.-%, and preferably is free of aluminum oxide.

The electrophoretic ink comprises the at least one surface-treated silica, preferably the at least one surface-treated fumed silica, preferably in an amount of 2 to 30 wt.-%, more preferably in an amount of 5 to 20 wt.-%, based on the total weight of the electrophoretic ink.

The present invention further refers to a method for preparing an electrophoretic ink, the method comprising the steps of
a) providing at least one carrier fluid as defined herein,
b) providing pigment particles as defined herein,
c) optionally providing at least one dispersing agent as defined herein,
d) providing a mixture of charge control agents as defined herein,
e) providing at least one surface-treated silica, preferably at least one surface-treated fumed silica, as defined herein, and
f) combining the at least one carrier fluid of step a), the pigment particles of step b), the optional dispersing agent of step c), the mixture of charge control agents of step d) and the at least one surface-treated silica of step e).

The step of combining can be carried out with any conventional combining method known to the skilled person. For example, the combining can be carried out by mixing the at least one carrier fluid of step a), the pigment particles of step b), the optional dispersing agent of step c), the mixture of charge control agents of step d) and the at least one surface-treated silica of step e).

In one embodiment, step f) is carried out by mixing and dispersing the components by using beads. The beads can be any beads known in the art for mixing and dispersing. Preferably, the beads are zirconium dioxide beads, more preferably zirconium dioxide beads having a particle size d₅₀ from 0.1 to 1 mm, such as from 0.2 to 0.8 mm.

It is preferred that combining step f) is carried out by mixing the at least one carrier fluid of step a), the pigment particles of step b), the optional dispersing agent of step c) and the mixture of charge control agents of step d) to obtain a mixture of the components. The at least one surface-treated silica of step e) is subsequently added to the obtained mixture of the at least one carrier fluid of step a), the pigment particles of step b), the optional dispersing agent of step c) and the mixture of charge control agents of step d).

In one embodiment, the method further comprises a step g) of combining the mixture obtained in step f) with a mixture comprising, preferably consisting of, at least one carrier fluid and a mixture of charge control agents. This step is advantageous in order to avoid the formation of pigment agglomerates.

The mixture comprising, preferably consisting of, at least one carrier fluid and a mixture of charge control agents comprises the mixture of charge control agents preferably in an amount ranging from 15 to 40 wt.-%, more preferably from 20 to 32 wt.-%, based on the total weight of the mixture. Accordingly, the mixture comprising, preferably consisting of, at least one carrier fluid and a mixture of charge control agents comprises the at least one carrier fluid preferably in an amount ranging from 60 to 85 wt.-%, more preferably from 68 to 80 wt.-%, based on the total weight of the mixture.

It is appreciated that the at least one carrier fluid in the mixture comprising, preferably consisting of, at least one carrier fluid and a mixture of charge control agents of step g) and the at least one carrier fluid provided in step a) are preferably the same.

Additionally or alternatively, the mixture of charge control agents in the mixture comprising, preferably consisting of, at least one carrier fluid and a mixture of charge control agents of step g) and the mixture of charge control agents provided in step d) are preferably the same.

If the method comprises step g), the mixture obtained in step f) and the mixture comprising, preferably consisting of, at least one carrier fluid and a mixture of charge control agents are preferably combined in a weight ratio [mixture obtained in step f)/mixture added in step g)] ranging from 5:1 to 1:1, preferably from 3:1 to 1:1 and most preferably from 2:1 to 1:1.

The present invention is further directed to an electrophoretic display comprising
a) a top layer and a bottom layer, wherein at least one is transparent, and
b) an array of cells sandwiched between the top layer and the bottom layer and the cells are at least partially filled with the electrophoretic ink as defined herein.

In a preferred embodiment, the top layer and the bottom layer are transparent.

Furthermore, the present invention is directed to an electrophoretic smart window comprising
a) a top layer and a bottom layer, wherein the top layer and the bottom layer are transparent, and
b) an array of cells sandwiched between the top layer and the bottom layer and the cells are at least partially filled with the electrophoretic ink as defined herein.

The electrophoretic display or smart window can be of any conventional arrangement known to the skilled person for electrophoretic displays or smart windows.

Advantageous arrangements of electrophoretic displays or smart windows are displayed in FIGS. 1 to 4.

For example, the top layer and the bottom layer of the electrophoretic display or smart window cell are electrically conducting layers, e.g. by using one or more layers of indium tin oxide (ITO). Preferably, the top layer and the bottom layer are transparent, more preferably the top layer and the bottom layer are made of ITO coated glass. Thus, the top layer and the bottom layer are preferably electrically conducting layers and transparent, e.g. made of ITO coated glass (see e.g. FIGS. 1 to 5). It is appreciated that the display cell is arranged such that it includes a reflective layer is fixed to the ITO coated glass bottom layer (see FIGS. 1 and 4). In contrast thereto, the smart window cell is free of a reflective layer fixed to the ITO coated glass bottom layer (see FIGS. 2 and 5).

The top layer and the bottom layer of the electrophoretic display or smart window cell are preferably arranged such that they are separated by spacers (see e.g. FIGS. 1 to 5). The formed cells are preferably at least partially filled with the electrophoretic ink as defined herein.

In one embodiment, the top layer and the bottom layer of the electrophoretic display or smart window cell are thus ITO coated glass and are separated by spacers.

In one embodiment of the electrophoretic display, two or more display cells are stacked on each other. In this arrangement, the cells are preferably joined to each other, i.e. the bottom layer of one cell to the top layer of another cell, by a binder layer (see e.g. FIG. 4). Preferably, each cell is at least partially filled with the same or different black or coloured electrophoretic ink, preferably coloured electrophoretic ink.

In an alternative embodiment, a single display cell is provided. In this arrangement, the cell is preferably at least partially filled with a black or coloured electrophoretic ink.

In one embodiment of the smart window, two or more display cells are stacked on each other. In this arrangement, the cells are preferably joined to each other, i.e. the bottom layer of one cell is joined to the top layer of another cell, by a binder layer (see e.g. FIG. 5). Preferably, each cell is at least partially filled with the same or different black or coloured electrophoretic ink, preferably coloured electrophoretic ink.

In an alternative embodiment, a single smart window cell is provided. In this arrangement, the cell is preferably at least partially filled with the black or coloured electrophoretic ink.

In view of the very good results obtained, the present invention is also directed to the use of an electrophoretic ink, as defined herein, in electrophoretic displays or smart windows.

The invention also relates to the use the of at least one surface-treated silica as defined herein, preferably together with a mixture of charge control agents as defined herein, for improving the bistability of an electrophoretic ink. In this regard, it is to be noted that the inventors surprisingly found out that the presence of at least one surface-treated silica in an electrophoretic ink improves the bistability such that values of more than 15 seconds are reached.

As regards the electrophoretic ink, the at least one surface-treated silica and the mixture of charge control agents, it is referred to the comments provided above when defining the electrophoretic ink, the at least one surface-treated silica, the mixture of charge control agents and embodiments thereof in more detail.

The scope and interest of the invention will be better understood based on the following examples which are intended to illustrate certain embodiments of the invention and are non-limitative.

### BRIEF DESCRIPTION OF FIGURES

FIG. 1 refers to a schematic illustration of a display cell containing a black or coloured electrophoretic ink.

FIG. 2 refers to a schematic illustration of a smart window cell containing a black or coloured electrophoretic ink.

FIG. 3 refers to a schematic illustration of a display or smart window cell viewed from above.

FIG. 4 refers to a schematic illustration of stacked display cells containing coloured electrophoretic inks.

FIG. 5 refers to a schematic illustration of stacked smart window cells containing coloured electrophoretic inks.

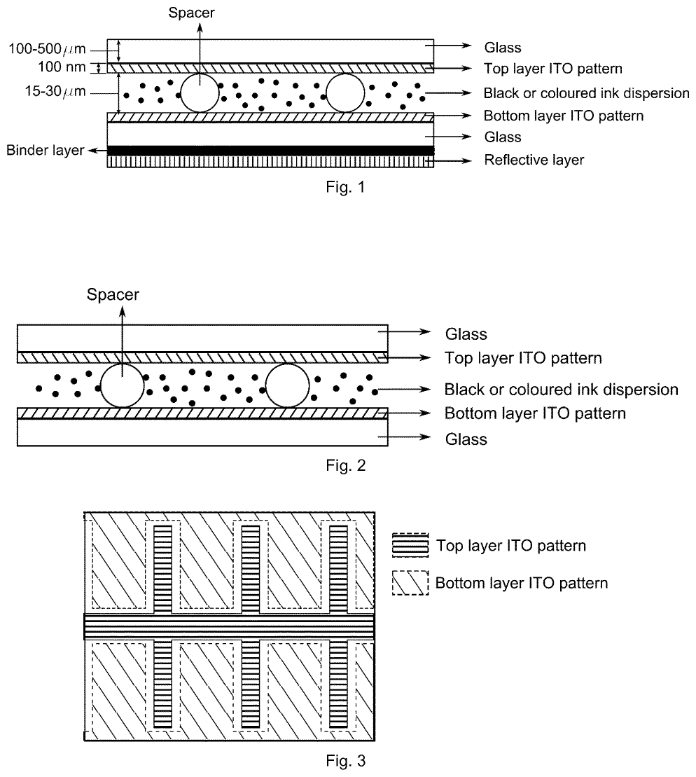

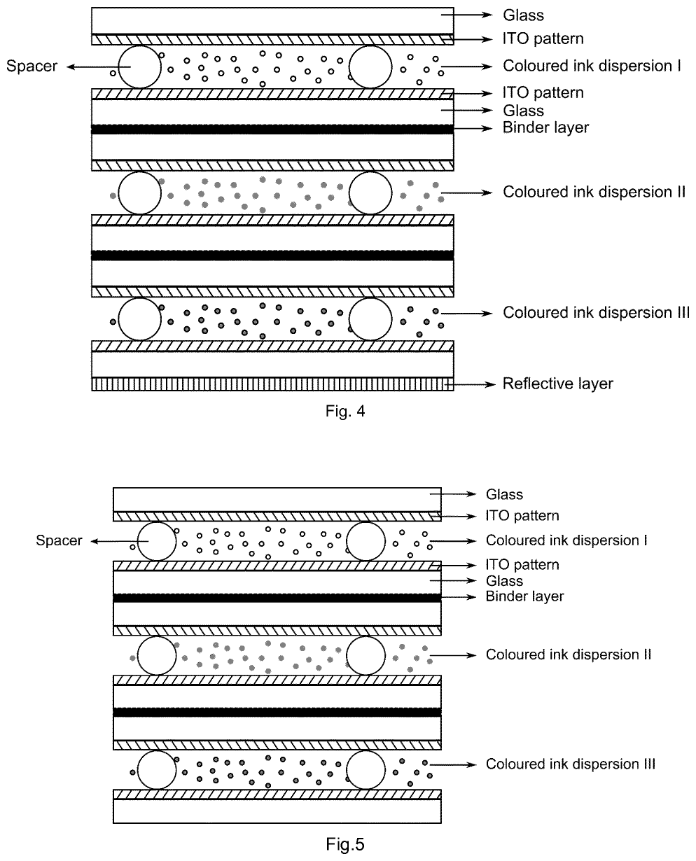

### EXAMPLES

The following materials were used:

### 1. Silica Materials

In this application, silica materials are defined as an oxide of silicon with the chemical formula of SiO₂ in the bulk. Both commercially available silica materials and surface-treated silica materials were used in this invention.

### 1.1 Commercially Available Silica Materials

Fumed silica powders (surface area 200-400 m² g⁻¹) were obtained from Sigma-Aldrich, as well as from Evonik: AEROSIL® 200, AEROSIL® 255, AEROSIL® 300, and AEROSIL® 380.

The following surface-treated fumed silica were obtained from Evonik: AEROSIL® R 104, AEROSIL® R 106, AEROSIL® R 208, AEROSIL® R 709, AEROSIL® R 711, AEROSIL® R 805, AEROSIL® R 816, AEROSIL® R 972, AEROSIL® R 974, AEROSIL® R 8200, AEROSIL® R 812 S, AEROSIL® R 976 S, AEROSIL® RX 50, AEROSIL® RX200, AEROSIL® RY50, AEROSIL® RY 51, AEROSIL® RY 200, AEROSIL® NX 90 S, and AEROSIL® NX 130.

### 1.2 Methods

The weight median particle size d₅₀ of the surface-treated silica was determined using TEM. The method and the instrument are known to the skilled person and are commonly used to determine the size of silica or other pigment materials.

The specific surface area (in m²/g) of the surface-treated silica was determined by using the BET method in accordance with ISO 9277:2010 and nitrogen as adsorbing gas. The method is known to the skilled person and is commonly used to determine the specific surface area.

The bistability was determined by measuring the Lightness (L*) over time by using a commercially available device for measuring the Lightness. The method and the instrument are known to the skilled person and are commonly used to determine the Lightness. In particular, the display filled with the electrophoretic ink is first driven from the black state to the white state (about 71 L*) by applying a voltage of +15 V or −15 V (depending on the charge of the pigment particle surface) during 4 to 30 seconds. Then, the display is switched from the white state to the black state again by switching off the voltage and the time required to reach a drop in Lightness of 7 L* is determined. The time required to reach a drop in Lightness of 7 L*corresponds to the determined bistability.

The contrast is determined by measuring the reflection in the black state as well as the white state by using a commercially available device for measuring the reflection. The method and the instrument are known to the skilled person and are commonly used to determine the reflection. In particular, the reflection of the display filled with the electrophoretic ink is measured in the black state and the white state which is obtained by applying a voltage of +15 V or −15 V (depending on the charge of the pigment particle surface). The reflection ratio between the white state and the black state corresponds to the determined contrast.

### 1.3 Surface-Treated Silica

Surface-treated silica materials were prepared by anchoring molecules (so-called “surface groups”) to the surface of fumed silica. The surface treatment process is given in the following examples.

### Example 1

2.0 g of fumed silica (obtained from Sigma-Aldrich, surface area 200 m² g⁻¹) were dispersed in 100 mL ethanol (95%) at 25° C. for 2 h, 1.0 g of docosanylsilane, or octadecylsilane, or hexadecylsilane, or dodecylsilane, or decylsilane, or octylsilane, or hexylsilane were added to the silica dispersion. The reaction mixture was aged for 15-72 h under stirring at 25° C. After removing the solvent in a rotary evaporator, the obtained powder material was dried in an oven at 120° C. for 2 h.

### Example 2

2.0 g of fumed silica (obtained from Sigma-Aldrich, surface area 400 m² g⁻¹) were dispersed in 100 mL ethanol (95%) at 25° C. for 2 h, 2.0 g of docosanylsilane, or octadecylsilane, or hexadecylsilane, or dodecylsilane, or decylsilane, or octylsilane, or hexylsilane were added to the silica dispersion. The reaction mixture was aged for 15-72 h under stirring at 25° C. After removing the solvent in a rotary evaporator, the obtained powder material was dried in an oven at 120° C. for 2 h.

### Example 3

1.0 g of fumed silica 1 (obtained from Sigma-Aldrich, surface area 200 m² g⁻¹) and 1.0 g of fumed silica 2 (surface area 400 m² g⁻¹) were mixed and dispersed in 100 mL ethanol (95%) at 25° C. for 2 h, 1.5 g of docosanylsilane, or octadecylsilane, or hexadecylsilane, or dodecylsilane, or decylsilane, or octylsilane, or hexylsilane were added to the silica dispersion. The reaction mixture was aged for 15-72 h under stirring at 25° C. After removing the solvent in a rotary evaporator, the obtained powder material was dried in an oven at 120° C. for 2 h.

### Example 4

2.0 g of fumed silica (obtained from Sigma-Aldrich, surface area 200 m² g⁻¹) were dispersed in 100 mL ethanol (95%) at 25° C. for 2 h, 1.0 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. The reaction mixture was aged for 15-72 h under stirring at 25° C. After removing the solvent in a rotary evaporator, the obtained powder material was dried in an oven at 120° C. for 2 h.

### Example 5

2.0 g of fumed silica (obtained from Sigma-Aldrich, surface area 400 m² g⁻¹) were dispersed in 100 mL ethanol (95%) at 25° C. for 2 h, 2.0 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. The reaction mixture was aged for 15-72 h under stirring at 25° C. After removing the solvent in a rotary evaporator, the obtained powder material was dried in an oven at 120° C. for 2 h.

### Example 6

1.0 g of fumed silica 1 (Sigma Aldrich, surface area 200 m² g⁻¹) and 1.0 g of fumed silica 2 (surface area 400 m² g⁻¹) were mixed and dispersed in 100 mL ethanol (95%) at 25° C. for 2 h, 1.5 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. The reaction mixture was aged for 15-72 h under stirring at 25° C. After removing the solvent in a rotary evaporator, the obtained powder material was dried in an oven at 120° C. for 2 h.

### Example 7

2.0 g of fumed silica (Sigma Aldrich, surface area 200 m² g⁻¹) were dispersed in 100 mL ethanol (95%) at 25° C. for 2 h, 0.5 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane was added to the silica dispersion. 0.5 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 8

2.0 g of fumed silica (obtained from Sigma-Aldrich, surface area 400 m² g⁻¹) were dispersed in 100 mL ethanol (95%) at 25° C. for 2 h, 1.0 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 1.0 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 9

1.0 g of fumed silica 1 (obtained from Sigma-Aldrich, surface area 200 m² g⁻¹) and 1.0 g of fumed silica 2 (surface area 400 m² g⁻¹) were mixed and dispersed in 100 mL ethanol (95%) at 25° C. for 2 h, 0.75 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 0.75 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 10

2.0 g of fumed silica (obtained from Sigma-Aldrich, surface area 200 m² g⁻¹) were dispersed in 100 mL ethanol (95%) at 25° C. for 2 h, 0.75 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 0.25 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 11

2.0 g of fumed silica (obtained from Sigma-Aldrich, surface area 400 m² g⁻¹) were dispersed in 100 mL ethanol (95%) at 25° C. for 2 h, 1.5 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 0.5 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 12

1.0 g of fumed silica 1 (obtained from Sigma-Aldrich, surface area 200 m² g⁻¹) and 1.0 g of fumed silica 2 (surface area 400 m² g⁻¹) were mixed and dispersed in 100 mL ethanol (95%) at 25° C. for 2 h, 1.125 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 0.375 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 13

2.0 g of fumed silica (obtained from Sigma-Aldrich, surface area 200 m² g⁻¹) were dispersed in 100 mL ethanol (95%) at 25° C. for 2 h, 0.25 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 0.75 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 14

2.0 g of fumed silica (obtained from Sigma-Aldrich, area 400 m² g⁻¹) were dispersed in 100 mL ethanol (95%) at 25° C. for 2 h, 0.5 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 1.5 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### Example 15

1.0 g of fumed silica 1 (obtained from Sigma-Aldrich, surface area 200 m² g⁻¹) and 1.0 g of fumed silica 2 (obtained from Sigma-Aldrich, surface area 400 m² g⁻¹) were mixed and dispersed in 100 mL ethanol (95%) at 25° C. for 2 h, 0.375 g of dimethoxydimethylsilane, or ethyl(trimethoxy)silane, or trimethoxy(propyl)silane, or isobutyl(trimethoxy)silane, or [3-(methacryloyloxy)propyl]trimethoxysilane were added to the silica dispersion. 1.125 g of docosanylsilane, or octadecylsilane, or hexadecylsilane, or dodecylsilane, or decylsilane, or octylsilane, or hexylsilane were added to the mixture afterwards. The reaction mixture was aged for 15-72 h under stirring at 25° C. After removing the solvent in a rotary evaporator, the obtained powder material was dried in an oven at 120° C. for 2 h.

### 2. Application of Silica Materials in Electrophoretic Ink

Electrophoretic ink black, yellow, magenta, and cyan were prepared as described in unpublished European patent application 16 179 079.5

A typical formulation of electrophoretic ink black contained 2.0-3.0% pigment, 0.2-0.3% dispersant, 15.0-20.0% charge control agent, and dodecane.

A typical formulation of electrophoretic ink yellow contained 0.5-2.0% pigment, 0.1-1.0% dispersant, 15.0-20.0% charge control agent (mixed PDMS-amine and PDMS-ammonium), and dodecane.

A typical formulation of electrophoretic ink magenta contained 1.0-2.5% pigment, 0.5-1.5% dispersant, 15.0-20.0% charge control agent, and dodecane.

A typical formulation of electrophoretic ink cyan contained 0.5-2.5% pigment, 0.1-2.0% dispersant, 5.0-20.0% charge control agent, and dodecane.

The (surface-treated) silica materials were added to the electrophoretic ink and homogenized in a Skandex. Afterwards the ink-(surface-treated) silica mixture was applied in a test cell and the performance of the ink was recorded and evaluated. A typical test cell included two glass planes with indium tin dioxide (ITO) coating as electrodes. The two glass planes were assembled with a cell gap of 15 μm.

### Example 0 (Comparative)

0.5 g black pigment (such as Irgaphor® Black, Paliogen® Black, Paliotol® Black, or their mix), 0.05 g dispersant, 0.5 g PDMS-amine, 1.0 g PDMS-ammonium, and 7.95 g dodecane were mixed with micro pearls in a vial and dispersed in Skandex for at least 45 h. The obtained preliminary ink was diluted with 0.4 g PDMS-amine, 1.5 g PDMS-ammonium, and 8.1 g dodecane to a final formulation of 2.5% pigment, 0.25% dispersant, 5.0% PDMS-amine, 11.3% PDMS-ammonium, and 80.95% dodecane. Bistability was 0.6 seconds and contrast was 14.

### Example 1 (Comparative)

0.5 g black pigment (such as Irgaphor® Black, Paliogen® Black, Paliotol® Black, or their mix), 0.05 g dispersant, 0.5 g PDMS-amine, 1.0 g PDMS-ammonium, and 7.95 g dodecane were mixed with micro pearls in a vial and dispersed in Skandex for at least 45 h. The obtained preliminary ink was diluted with 0.4 g PDMS-amine, 1.5 g PDMS-ammonium, and 8.1 g dodecane to a final formulation of 2.5% pigment, 0.25% dispersant, 5.0% PDMS-amine, 11.3% PDMS-ammonium, and 80.95% dodecane. 3.5 g fumed silica (surface area 200-400 m² g⁻¹) were added to the obtained ink and the mixture was dispersed in Skandex for 2.5 h. Bistability was from 6-10 seconds and contrast was between 7 and 10.

### Example 2 (Inventive)

0.5 g black pigment (such as Irgaphor® Black, Paliogen® Black, Paliotol® Black, or their mix), 0.05 g dispersant, 0.5 g PDMS-amine, 1.0 g PDMS-ammonium, and 7.95 g dodecane were mixed with micro pearls in a vial and dispersed in Skandex for at least 45 h. The obtained preliminary ink was diluted with 0.4 g PDMS-amine, 1.5 g PDMS-ammonium, and 8.1 g dodecane to a final formulation of 2.5% pigment, 0.25% dispersant, 5.0% PDMS-amine, 11.3% PDMS-ammonium, and 80.95% dodecane. 4.4 g surface-treated silica (from Example 10 in 1.3) were added to the obtained ink and the mixture was dispersed in Skandex for 2.5 h. Bistability for all Examples was from 10-20 seconds and contrast was between 10 and 14.

### Example 3 (Inventive)

0.5 g yellow pigment (such as Irgalite® Yellow, Irgaphor® Yellow, Irgazin® Yellow, Cromophtal® Yellow, Paliotol® Yellow, or their mix), 0.1 g dispersant, 0.7 g PDMS-amine, 1.4 g PDMS-ammonium, and 7.3 g dodecane are mixed with micro pearls in a vial and dispersed in Skandex for 45 h. The obtained preliminary ink was diluted with 1.8 g PDMS-amine, 5.5 g PDMS-ammonium, and 32.8 g dodecane to a final formulation of 1.0% pigment, 0.2% dispersant, 5.0% PDMS-amine, 12.5% PDMS-ammonium, and 81.3% dodecane. 12.0 g surface-treated silica (from Example 1-15 in 1.3) is added to the obtained ink and the mixture is dispersed in Skandex for 2.5 h. Bistability for all Examples was from 10-20 seconds and contrast was between 10 and 14.

### Example 4 (Inventive)

0.5 g magenta pigment (Cinquasia® Magenta, Cinquasia® Violet, Cromophtal® Violet, Irgazin® Red, or their mix), 0.2 g dispersant, 0.6 g PDMS-amine, 1.4 g PDMS-ammonium, and 7.3 g dodecane were mixed with micro pearls in a vial and dispersed in Skandex for 45 h. The obtained preliminary ink was diluted with 1.4 g PDMS-amine, 6.2 g PDMS-ammonium, and 32.4 g dodecane to a final formulation of 1.0% pigment, 0.4% dispersant, 4.0% PDMS-amine, 14.0% PDMS-ammonium, and 80.6% dodecane. 12.0 g surface-treated silica (from Example 1-15 in 1.3) were added to the obtained ink and the mixture was dispersed in a Skandex for 2.5 h. Bistability for all Examples was from 10-20 seconds and contrast was between 10 and 14.

### Example 5 (Inventive)

0.5 g cyan pigment (Cromophtal® Cyan, Heliogen® Blue, Paliogen® Blue, or their mix), 0.25 g dispersant, 0.5 g PDMS-amine, 1.2 g PDMS-ammonium, and 7.55 g dodecane were mixed with micro pearls in a vial and dispersed in Skandex for 45 h. The obtained preliminary ink was diluted with 1.1 g PDMS-amine, 3.5 g PDMS-ammonium, and 85.4 g dodecane to a final formulation of 0.5% pigment, 0.25% dispersant, 1.2% PDMS-amine, 4.3% PDMS-ammonium, and 93.35% dodecane. 24.0 g surface-treated silica (from Example 1-15 in 1.3) were added to the obtained ink and the mixture was dispersed in a Skandex for 2.5 h. Bistability for all Examples was from 10-20 seconds and contrast was between 10 and 14.

### Example 6 (Inventive)

0.5 g black pigment (such as Irgaphor® Black, Paliogen® Black, Paliotol® Black, or their mix), 0.05 g dispersant, 0.5 g PDMS-amine, 1.0 g PDMS-ammonium, and 7.95 g dodecane were mixed with micro pearls in a vial and dispersed in Skandex for at least 45 h. The obtained preliminary ink was diluted with 0.4 g PDMS-amine, 1.5 g PDMS-ammonium, and 8.1 g dodecane to a final formulation of 2.5% pigment, 0.25% dispersant, 5.0% PDMS-amine, 11.3% PDMS-ammonium, and 80.95% dodecane. 5.0 g of surface-treated silica AEROSIL® R 709 or AEROSIL® R 711 or AEROSIL® R 805 or AEROSIL® R 816 or the mixture of them were added to the obtained ink and the mixture was dispersed in Skandex for 2.5 h. Bistability for all Examples was from 10-20 seconds and contrast was between 10 and 14.

### Example 7 (Inventive)

0.5 g black pigment (such as Irgaphor® Black, Paliogen® Black, Paliotol® Black, or their mix), 0.05 g dispersant, 0.5 g PDMS-amine, 1.0 g PDMS-ammonium, and 7.95 g dodecane were mixed with micro pearls in a vial and dispersed in Skandex for at least 45 h. The obtained preliminary ink was diluted with 0.4 g PDMS-amine, 1.5 g PDMS-ammonium, and 8.1 g dodecane to a final formulation of 2.5% pigment, 0.25% dispersant, 5.0% PDMS-amine, 11.3% PDMS-ammonium, and 80.95% dodecane. 3.75 g of surface-treated silica AEROSIL® R 709 or AEROSIL® R 711 or fumed silica (200-400 m² g⁻¹) or the mixture of them were added to the obtained ink and the mixture was dispersed in Skandex for 2.5 h. Bistability for all Examples was from 10-20 seconds and contrast was between 10 and 14.

1. An electrophoretic ink, comprising
a) at least one carrier fluid,
b) pigment particles dispersed in the at least one carrier fluid,
c) a mixture of charge control agents comprising
i) at least one polydimethylsiloxane substituted primary amine and/or polydimethylsiloxane substituted secondary amine and/or polydimethylsiloxane substituted tertiary amine, and
ii) at least one polydimethylsiloxane substituted quaternary ammonium with counterion, and
d) at least one surface-treated silica.

2. The electrophoretic ink according to claim 1, wherein the at least one carrier fluid is selected from the group consisting of an aliphatic hydrocarbon, a halogenated alkane, a silicon oil and a mixture thereof.

3. The electrophoretic ink according to claim 1, wherein the pigment particles are selected from the group consisting of color pigments, effect pigments, electrically conductive pigments, magnetically shielding pigments, fluorescent pigments, extender pigments, anticorrosion pigments, organic pigments, inorganic pigments, and a mixture thereof.

4. The electrophoretic ink according to claim 1, further comprising
at least one dispersing agent.

5. The electrophoretic ink according to claim 1, wherein component i) and component ii) in the mixture of charge control agents are present in a weight ratio [i)/ii)] ranging from 1:10 to 1:1.5.

6. The electrophoretic ink according to 5 claim 1, wherein component i) is a polydimethylsiloxane substituted tertiary amine.

7. The electrophoretic ink according to claim 1, wherein component i) is
a compound of Formula (IIa) 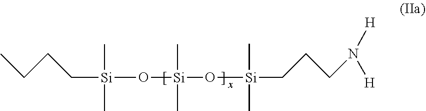
where x is an integer ranging from 5 to 20, and/or
a compound of the following Formula (IIb) 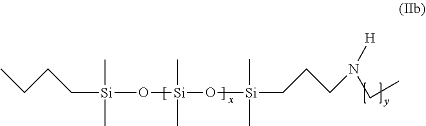
where x is an integer ranging from 5 to 20 and y is an integer ranging from 0 to 12, and/or
a compound of the following Formula (IIc) 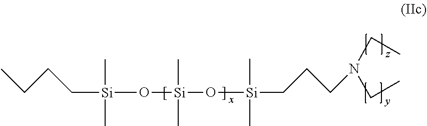
where x is an integer ranging from 5 to 20 and y and z are independently an integer ranging from 0 to 12.

8. The electrophoretic ink according to claim 1, wherein component ii) in the mixture of charge control agents is a compound of Formula (III) 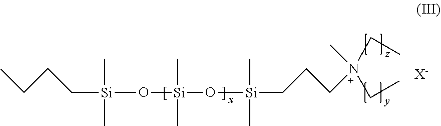
where x is an integer ranging from 5 to 20; y and z are independently an integer ranging from 0 to 12 and X⁻ is selected from the group consisting of iodide, bromide, chloride, methyl sulfate anion, and ethylsulfate anion.

9. The electrophoretic ink according to claim 1, wherein component ii) in the mixture of charge control agents is a compound of Formula (IV) 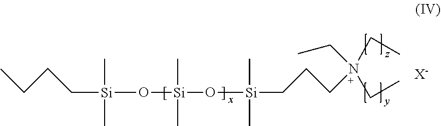
where x is an integer ranging from 5 to 20; y and z are independently an integer ranging from 0 to 12 and X⁻ is selected from the group consisting of iodide, bromide, chloride, methyl sulfate anion, and ethylsulfate anion.

10. The electrophoretic ink according to claim 1, wherein the at least one surface-treated silica
i) is at least one surface-treated fumed silica, and/or
ii) comprises aluminum oxide in an amount ranging from 0.5 to 22 wt.-%, based on a total weight of the at least one surface-treated silica, and/or
iii) comprises a treatment layer on a surface of the at least one surface-treated silica comprising a silicon-containing compound selected from the group consisting of a silane, a reaction product of a silane, a siloxane, a reaction product of a siloxane, a silazane, a reaction product of a silozane, a silicon oil, a reaction product of a silicon oil, and a mixture thereof.

11. The electrophoretic ink according to claim 1, wherein the at least one surface-treated silica has
i) a weight median particle size d₅₀ from 4 to 200 nm, and/or
ii) a specific surface area (BET) of from 10 to 400 m²/g as measured using nitrogen and in accordance with ISO 9277.

12. A method of preparing the electrophoretic ink according to claim 1, the method comprising
combining the at least one carrier fluid, the pigment particles, the mixture of charge control agents, the at least one surface-treated silica, and optionally at least one dispensing agent.

13. An electrophoretic display, comprising
a) a top layer and a bottom layer, wherein at least one of the top layer and the bottom layer is transparent, and
b) an array of cells sandwiched between the top layer and the bottom layer and the cells are at least partially filled with the electrophoretic ink according to claim 1.

14. A smart window, comprising
a) a top layer and a bottom layer, wherein the top layer and the bottom layer are transparent, and
b) an array of cells sandwiched between the top layer and the bottom layer and the cells are at least partially filled with the electrophoretic ink according to claim 1.

15. (canceled)

16. A method for improving bistability of an electrophoretic ink, the method comprising:
introducing at least one surface-treated silica into the electrophoretic ink.

17. The method according to claim 16, further comprising
introducing a mixture of charge control agents with the at least one surface-treated silica into the electrophoretic ink,
wherein the mixture of charge control agents comprises
i) at least one polydimethylsiloxane substituted primary amine and/or polydimethylsiloxane substituted secondary amine and/or polydimethylsiloxane substituted tertiary amine, and
ii) at least one polydimethylsiloxane substituted quaternary ammonium with counterion.

18. The electrophoretic ink according to claim 4, wherein the at least one dispersing agent is represented by Formula (I) 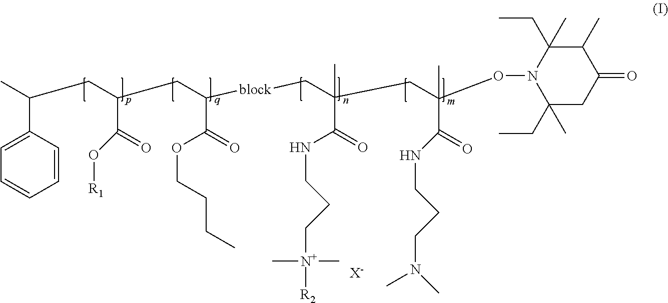
where p+q is an integer ranging from 30 to 200, n+m is an integer ranging from 5 to 50, X⁻ is an anion of a monovalent organic or inorganic acid, R₁ is a C₄-C₂₂-linear or branched alkyl group, and R₂ is a C₁-C₁₂-comprising group.
